(19) United States
(12) Patent Application Publication
(10) Pub. No.: US 2025/0249367 A1
(43) Pub. Date: Aug. 7, 2025

(54) SYSTEM AND METHOD OF MOTOR TASK SKILL ASSESSMENT

(71) Applicant: State Space Labs, Inc., New York, NY (US)

(72) Inventors: Kevin DESIMONE, Halifax (CA); Ian DONOVAN, Brooklyn, NY (US); Jennifer B. LISTMAN, Park City, UT (US); Marcia A. SAUL, Bournemouth (GB); Xinyu D. SONG, Cambridge, MA (US); Jason R. FULLER, New York, NY (US); David J. HEEGER, Park City, UT (US); Wayne E. MACKEY, New York, NY (US)

(73) Assignee: State Space Labs, Inc., New York, NY (US)

(21) Appl. No.: 19/087,753

(22) Filed: Mar. 24, 2025

Related U.S. Application Data
(63) Continuation-in-part of application No. 18/360,915, filed on Jul. 28, 2023.
Application No. 18/360,915 is a continuation-in-part of application No. 18/129,476, filed on Mar. 31, 2023.
Application No. 18/360,915 is a continuation-in-part of application No. 17/975,769, filed on Oct. 28, 2022, now Pat. No. 11,975,270.
Application No. 17/975,769 is a continuation of application No. 16/121,210, filed on Sep. 4, 2018, now Pat. No. 11,602,697.
(60) Provisional application No. 63/335,479, filed on Apr. 27, 2022.
(60) Provisional application No. 63/357,194, filed on Jun. 30, 2022.
(60) Provisional application No. 62/554,212, filed on Sep. 5, 2017.

(51) Int. Cl. A63F 13/798; A63F 13/67

(52) U.S. Cl. CPC A63F 13/798; A63F 13/67; A63F 2300/535

(57) ABSTRACT

A system and method may adjust the evaluation of input signals from an input device used by a game player, based on performance or motor acuity. A relationship or mapping between computer input device input and movement within a virtual environment may be adjusted based on the performance metric. An embodiment may measure or calculate a performance metric or motor acuity in a person playing a computer game by determining, for different target types, speed of the player and one of precision, accuracy and variability of the player; and determining motor acuity based on the relationship between speed of the player and the precision, accuracy or variability. The calculation may be using a statistical analysis; and may be by creating a best-fit line in a comparison of speed and variability; and transforming the best-fit line to a curve in a comparison of player speed and player precision.

### RELATED APPLICATION DATA

The present application is a continuation-in-part of prior U.S. application Ser. No. 18/360,915, filed on Jul. 28, 2023, which in turn is a continuation-in-part of prior U.S. application Ser. No. 18/129,476, filed on Mar. 31, 2023, which in turn claims benefit from U.S. provisional Patent Application No. 63/335,479, filed on Apr. 27, 2022, entitled “FLICKING SKILL ASSESSMENT”, and U.S. provisional Patent Application No. 63/357,194, filed on Jun. 30, 2022, entitled “FLICKING SKILL ASSESSMENT”; prior U.S. application Ser. No. 18/360,915 is also a continuation-in-part of prior U.S. application Ser. No. 17/975,769 filed on Oct. 28, 2022, which in turn is a continuation of prior U.S. application Ser. No. 16/121,210, filed on Sep. 4, 2018, entitled “SENSORIMOTOR ASSESSMENT AND TRAINING”, which in turn claims the benefit of prior U.S. provisional application 62/554,212, filed on Sep. 5, 2017. Each of these applications is incorporated herein by reference in its entirety.

### FIELD OF THE INVENTION

The present invention relates generally to the field of skill training and assessment. More specifically, embodiments of the present invention relate to skill training and assessment in video games.

### BACKGROUND OF THE INVENTION

Performance metrics for assessing motor skill performance change over time, or across players which may be useful in gaming, physical or cognitive therapy, and other fields, exist, but are not sufficiently efficient and accurate. Contrary to traditional sports, there are few performance metrics in video games and esports (e.g., competitive multiplayer video games) for assessing a player's skill and ability. First-person shooter (FPS) video games are centered on gun and other weapon-based combat in a first-person perspective, with the player controlling a player character. One measured skill relevant to video games is flicking skill, which measures players' skill with flick shots, a standard user input to some video games, where a user may for example quickly react to a target. Flicking, rapidly moving the crosshair to an object or enemy and firing a shot to damage or destroy the target, is a fundamental facet of FPS play. A flick shot may include taking shots where a player's aim or crosshairs begin a distance away from the target, and the player quickly flicks (e.g. by controlling a video game controller or by moving a computer mouse) so the aim moves to the target, e.g. almost concurrently with the player pulling the trigger or making a shot.

Performance in FPS video games relies on acquired perceptual and motor skills. Competitive players dedicate years advancing these skills prior to playing at a professional level. Despite the rapidly growing popularity of competitive esports, the field continues to lack established objective benchmarks for individual skill. Many of the commonly used performance metrics in esports are unreliable measures of individual skill. Particularly in team games, key benchmarks (e.g., kill-death ratio, damage dealt, win-rate) confound the ability of an individual player with that of their teammates, the opposing team, or the coordination of the team as a whole. For instance, a mediocre player is able to gain a high ranking by playing with individuals of a much higher skill level, and the opposite is true for a great player with lesser-skilled teammates. Reliable individual skill assessments with intra- and inter-individual comparisons both at a single time point and longitudinally are needed to characterize player rankings and efficacy of training.

Successful FPS play requires efficient identification and localization of relevant visual stimuli, and dynamic movements followed by well-timed shot responses. When playing with a computer mouse and keyboard, for example, flicking is achieved primarily by hand and arm (e.g., reach) movements. Protocols for measuring ballistic reach and eye movement kinematics are well established, and have been applied in a broad range of cognitive and visuomotor tasks. Yet specific knowledge regarding FPS performance is lacking. Visuomotor skills are specialized and are typically constrained to the contexts and modalities in which they are learned. Thus, previous visuomotor psychophysics research provides limited knowledge about FPS performance.

### SUMMARY OF THE INVENTION

A system and method may measure or calculate performance, a performance metric, or motor acuity, a visuomotor skill performance metric, in a person playing a computer task, gamified task, or computer game by determining, for a number of different target types, speed of the player and one of precision, accuracy and variability of the player (e.g. in movement or shots); and determining or calculating motor acuity based on the relationship between speed of the player and the one of precision, accuracy and variability of the player or player input. The calculation may be using a statistical analysis; and may be by creating a best-fit line in a comparison of speed and variability; and transforming the best-fit line to a curve in a comparison of player speed and player precision (1/variability).

Some embodiments evaluate the impact of hardware, software, and various other factors (e.g., mouse, mouse pad, rendering latency, posture, exercise, diet and dietary supplements, sleep, etc.) on gaming performance.

Some embodiments are applicable to other fields. Examples include: rehabilitation (assessment and training) for patients recovering from stroke, traumatic brain injury, or arm injury; concussion assessment, to determine if an individual may have suffered a concussion or brain injury, by comparing their performance with a baseline that was measured before the incident that may have caused an injury, or to determine if an athlete should return to play following a concussion; assessment, characterization and/or training for individuals who are learning to use a prosthetic limb; assessment, characterization and/or and training for patients with movement disorders (e.g., cerebral palsy); gamified assessment or characterization of sensorimotor and cognitive fitness or state, e.g., immersive games for military personnel that may run on mobile devices (phone, tablet, etc.) and that assess and monitor changes in cognitive fitness, readiness, and performance across the military lifecycle and in the field.

A computer-implemented method for adjusting the evaluation of input signals from a computer input device used by a player of a game, and/or performing sensorimotor or cognitive assessment or therapy of a patient, may monitor input in a game by a player using a computer input device, game controller, mouse, etc.; determine or calculate a performance metric or other metric of the input; and adjust a relationship between an input received via the computer input device and the movement of a virtual object, such as a virtual character, a weapon, etc., within the virtual environment of the game based on the performance metric. The relationship may be, e.g., one or more sensitivities of the computer input device; dots-per-inch moved by the virtual object for each unit of movement of the computer input device, or another relationship. The adjusting may include setting one or more sensitivities on the computer input device. The performance metric may include a distance between a projectile and a target; and a distance between a movement and the target; or other metrics. The computer input device may be for example a mouse; a game controller; a joystick; an accelerometer; a pointing device; a motion capture device; a Wii remote controller; an eye tracker; a computer vision system; a gyroscope; an absolute position headset; a six-degree-of-freedom headset; an inside-out tracking headset; or another device. The input may include aiming or targeting movement trajectories. Adjusting the relationship may include manipulating at least one of acceleration and velocity, or other adjustments. The adjusting may include manipulating at least one of a position, velocity, acceleration, higher-order temporal derivative of the position, orientation, angular velocity, angular acceleration, higher-order temporal derivative of the orientation, joint angle, angular velocity of the joint angle, angular acceleration of the joint angle, higher-order temporal derivatives of the joint angle of the input, DPI, lift-off distance, polling rate, button response/debounce time, and angle tuning, or other adjustments. The adjusting of the relationship may be performed by a computer program comprising the game, the input device, or another component. The performance metric may be for example movement kinematic performance metrics, shot performance metrics, speed, accuracy, precision, variability, position error reaction time, motor acuity, and score. Determining a performance metric of the movements may include for example determining a performance metric of trajectories of the movements. The performance metric may be based on for example mean; median; mode; variance; covariance; skewness; kurtosis; movement speed; peak movement speed; shot speed; a measure based on a target presentation duration threshold; a measure based on target hit rate; a measure based on time between target spawn or appearance and the first shot fired; a measure based on movements per second; a measure based on shots per second; movement variability; shot variability; a measure based on spatial error of the landing point of a movement to the target; a measure based on median absolute difference between the endpoint of the movement and the center of the target; and a measure based on a target size threshold.

A method or device may perform sensorimotor or cognitive assessment or therapy of a patient by for example parsing a time-series of patient movements based on input signals from an input controller to produce a plurality of parsed movements; compute, for a plurality of target types, speed of the patient input for a set of parsed movements, and precision and variability of the patient input for the set of parsed movements; compute motor acuity based on the relationship between speed of the patient input and precision of the patient input, wherein computing motor acuity comprises creating a best-fit line in a comparison of speed of the patient input and variability of the patient input; and transform the best-fit line to a curve in a comparison of patient speed and patient precision; and produce an assessment output that characterizes the patient's sensorimotor or cognitive fitness based on the motor acuity. Determining motor acuity may include performing a statistical analysis of speed and the one of precision and variability of the patient. Determining motor acuity may include determining a distance of the curve from the origin of a graph on which the curve is plotted. Patient input speed may include for example one of movement speed; peak movement speed; shot speed; a measure based on a target presentation duration threshold; a measure based on target hit rate; a measure based on time between target spawn or appearance and the first shot fired; a measure based on movements per second; and a measure based on shots per second. Variability of the patient may be for example one of movement variability; shot variability; a measure based on spatial error of the landing point of a movement to the target; a measure based on median absolute difference between the endpoint of the movement and the center of the target; and a measure based on a target size threshold. A method for performing sensorimotor or cognitive assessment or therapy of a patient may include, for a plurality of target types, speed of the patient input based on input signals from an input controller to a computer processor, and one of precision, accuracy and variability of the patient input based on input signals from the input controller to the computer processor; characterizing, a change in motor acuity by performing a multiple linear regression of speed of the patient input and one of precision, accuracy and variability of the patient input; and producing an assessment output that characterizes the patient's sensorimotor or cognitive fitness based on the motor acuity.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows example screenshots of a Gridshot (left panel) task and Sixshot (right panel) task, according to some embodiments.

FIG. 2 shows example screenshots of an Adaptive Reflexshot task, according to some embodiments.

FIG. 3 shows example movement trajectories and model fits, according to some embodiments.

FIG. 4 is an example illustration of movement trajectories, showing hypometric movement from A toward B, and hypermetric movement from C past D, according to some embodiments.

FIG. 5 shows an example of movement parsing utilizing changes in movement direction, according to some embodiments.

FIG. 6 shows example distributions of movement kinematic performance metrics for a Gridshot task (top row) and a Sixshot task (bottom row), according to some embodiments.

FIG. 7 shows an example of flicking skill assessment, utilizing time between target spawn and the first shot fired and shot variability of the first shot that was fired, according to some embodiments.

FIG. 8 is a flowchart depicting a method according to embodiments of the present invention.

FIG. 9 depicts a computer system according to embodiments of the present invention.

FIG. 10 depicts a computer device according to embodiments of the present invention.

FIG. 11 shows example speed-accuracy tradeoffs and flicking skill assessments, using an Adaptive Reflexshot task, according to some embodiments.

FIG. 12 shows example comparison of movement kinematic performance metrics for Gridshot versus Sixshot, according to some embodiments.

FIG. 13 shows example correlation between individual differences in movement kinematics performance metrics and motor acuity, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in specific forms other than the examples presented herein without departing from the spirit or essential characteristics thereof. The foregoing embodiments are therefore to be considered in all respects illustrative rather than limiting of the invention described herein. Scope of the invention is thus indicated by the appended claims, rather than by the foregoing description.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer or other electronic computing device, that manipulates and/or transforms data represented as physical (e.g., electronic) quantities within the computer's registers or memories into other data similarly represented as physical quantities within the computer's registers and/or memories or other non-transitory storage medium that may store instructions to perform operations and/or processes.

### Introduction

Embodiments may assess video game inputs to measure performance metrics, e.g. flicking skill or motor acuity for a person for example based on flicking movements, and movement kinematics performance metrics of esports players. Player activity as described herein (e.g. flicking, firing a shot) is typically provided as input to a computer system, the player typically viewing a computer-generated display. A player “moving” may refer, for example, to a user providing input, e.g. using a game controller or computer mouse (e.g., input device 135 or 205) which causes some displayed representation of that user to move, or to move the field of view.

In some embodiments, the orientation of the player's view of the environment, controlled by the input controller or device, is recorded in Euler angles and sampled, e.g. at 120 Hz. Other sampling rates can be used instead of 120 Hz; one embodiment is implemented with sampling rates ranging from 30-240 Hz. Other representations of player orientation and movement can be used instead of Euler angles, such as pixels or quaternions. A game entity such as an aiming image or icon, e.g. a crosshair, may be marked in some embodiments with a dot at the center of the screen, and may correspond to the direction in which a shot would be fired, and may be used to determine precision, accuracy or error. When triggered (e.g. when the user commands the system to fire a shot using an input device or controller), the shot may move, in the virtual environment of the game, in a straight line pointing away from the player's virtual avatar. The shot may then strike an entity such as a target, and thus the relative game or screen position of the aiming image and target may be used to determine precision, error or accuracy.

Some embodiments utilize or take input from products from Aim Lab, such as Aim Lab's first-person shooter (FPS) assessment and training game, to measure using one or more games or gamified tasks that involve shooting targets with a number of different of target types (e.g. target sizes) and/or target presentation durations. Human performance is known to exhibit a speed-accuracy tradeoff. The different target sizes and durations incentivize players to make faster and less precise shots, or to make slower and more precise shots. The adaptive features of some gamified tasks, e.g., titrating target presentation durations and/or target sizes, may result in an assessment with no “ceiling effect”.

Embodiments of the present invention may provide improvements over prior technology used for assessing motor acuity, or game performance. Prior art methods of assessing player performance may not be as effective as those of embodiments of the present invention. One prior method of characterizing visuomotor performance is the use of Fitts Law for a wide range of tasks including an FPS task. Fitts Law predicts that the time required to rapidly move to a target is a function of the ratio between the distance to the target and either the size of the target or the spatial error of the movement. Motor acuity, complementary to Fitts Law, may be defined as the ability to execute actions more precisely and within a shorter amount of time. In one example Fitt's Law application to FPS gaming was based on measuring shot time (e.g., elapsed time between the destruction of a target and the first shot at the subsequent target), target distance (e.g., angular distance to the target when it first appeared) and shot spatial error (e.g., angular distance between the shot and the target (e.g. some distance from the border of the target, the center of the target, etc.), or the center of the target) for two gamified tasks, each task including one of the two target sizes. Performance, combined across the two target sizes, was poorly characterized by Fitts Law. In one example, for each target the shot time, target distance and shot error were measured. The logarithm of the ratio of target distance and shot error was computed, separately for each target, and then binned by decile. For each bin was computed: 1) the median shot time; and 2) the median logarithm of the ratio of target distance and shot error. Fitts Law provided a good characterization of behavioral performance when fit separately to the data from each task (e.g., separately for each target size), but a very poor characterization of the data when combined across the two tasks (e.g., combined across the two target sizes). In other words, shot times were well predicted by Fitts Law as a function of target distance and target error for each target size separately, but not for both target sizes together.

This failure of Fitts Law may reflect a difference in strategy between the two tasks, e.g., that players tended to be more “swipy” for large targets than for small targets. A previous study found excellent agreement between Fitts Law and behavior in an FPS task, but the participants in that study were either amateur gamers or did not report playing FPS games at all. Swiping is an advanced skill that is commonly used by highly competitive and professional players when speed is of paramount importance.

Embodiments of the present invention may provide a better method to measure skilled performance, one that isolates skill from the player's strategy. Some embodiments may assess skill or motor acuity as a relationship of a speed metric and a variability or precision metric. Each of speed and variability or precision may be measured based on player input such as movement kinematics performance metrics (e.g. median movement speed, median movement landing error) or shot performance metrics (e.g. median elapsed time to first shot and median first shot error), typically multiple data points being used to calculate speed and variability (and typically multiple data points of one target type being used to compute speed, precision, variability and/or accuracy). Precision may be 1 divided by variability.

Embodiments may measure performance metrics, such as motor acuity in a game, based on a speed/precision or speed/accuracy tradeoff. In some embodiments this is based on user input for a plurality of trials, with a plurality of different target types or sizes, where some trials may use the same target type, e.g. 100 trials using two target sizes, where 50 trials use target size A and 50 use target size B. Some embodiments rely on evaluating a player on two or more different tasks, typically performed back-to-back, or close together in time (e.g. on the same day, in the same hour, etc., as the player's skill may change over longer time periods), each task typically defined by a different target type or size. Each task may have distinct incentives regarding speed and precision. Embodiments may evaluate a player in isolation (e.g. not against other players) or against other players. Embodiments may evaluate a player by having the player perform a game or gamified task using a first target type (e.g. large target) then perform a game or gamified task using a second target type (e.g. smaller target), and possibly repeating with other target types. Some embodiments may interleave (e.g., in randomly shuffled order) the different target types or sizes in a single game or gamified task. Some embodiments may measure performance metrics, e.g., motor acuity, by analyzing or plotting the relationship or tradeoff between speed and accuracy, variability or precision in the tasks, e.g. by measuring the distance of a curve or function plotting speed vs. precision from the origin of a graph. Such a curve or function may represent a speed-accuracy tradeoff (SAT). Some embodiments perform a statistical analysis to determine if there is a statistically significant change or difference in speed and accuracy, variability or precision, e.g., between players, over time (e.g., with practice or training) or across different conditions (e.g., impact of hardware, software, and various other factors such as mouse, mouse pad, rendering latency, posture, exercise, diet and dietary supplements, sleep, etc.) on gaming performance.

Embodiments may determine motor acuity or other performance metrics based on a tradeoff or comparison between performance metrics such as movement speed and movement variability, movement precision or movement accuracy. In one embodiment, this may be done for a number of different target types or sizes: the player may perform a certain task, e.g. the same task, more than once, each time for a different target type or the different target types may be interleaved during each round of the task. For data acquired with two or more target types a statistical analysis may be performed or a curve generated, analyzing speed/accuracy relationship or tradeoff, speed/precision relationship or tradeoff, or another relationship. (Some tasks may include only one target type; other tasks may interleave different target types in the same task.) A curve, e.g. an SAT (speed-accuracy tradeoff) curve, may be generated: the curve may represent the possible combinations of movement speed and movement precision given the player's skill (typically measured on a certain day or certain session, local in time), with the player's current strategy determining where along the curve their current speed and precision is drawn from. Embodiments may measure both speed and another performance metric such as accuracy, variability or precision; use of a single performance metric as a proxy for motor acuity may be less effective, as motor acuity may be defined by both speed and accuracy. Further, a line fitted to a player's movement speed and movement variability may be used to help a player adjust strategy: if the slope is negative, near zero, or near vertical, this indicates that the player did not make the trade-off between speed and precision to maximize performance between scenarios (e.g., target types). In some embodiments such an analysis may be done for a number of players, to rate or rank the players against each other. Embodiments may use such statistical analysis or graphing to compare the performance of a player (a “newly seen” player) to that of other players stored in a database; to that player in a different day (e.g. to gauge improvement or decline, or to gauge performance of a player over time).

Embodiments may likewise determine motor acuity based on shot performance metrics such as shot speed (e.g., 1 over median elapsed time between target appearance and the first shot toward each target) and shot variability (e.g., variability of shot locations relative to the targets or centers of the targets), shot precision or shot accuracy.

In one example three different target sizes may be used: e.g. small target size; medium target size; and large target size. Shot speed (e.g., 1 over median elapsed time between target appearance and the first shot toward each target) and shot variability (e.g., median angular shot error wherein shot error is the absolute value of the angle between the shot and the target or center of the target) may be measured, separately for each target size and individually for each player. For each player a line may be determined as a best fit line to the shot speed (e.g., in units of seconds⁻¹) versus shot variability (e.g., in units of degrees) data from one player. Different best fit lines may be determined for each player. Such lines may be re-plotted as curves in terms of shot speed versus shot precision (in this example 1 over shot variability in units of degrees⁻¹). The resulting curves represent the transformed lines from each player. A diagonal dashed line may extend from the origin (0,0) to a multiple of (e.g., three times) the standard deviation plus the mean of the distribution of shot precision (x-axis) and shot speed (y-axis) across curves from all players. In some embodiments, the intersection of individual curves with the diagonal, indicates flicking skill: the further the intersection from the origin, the higher the skill.

Players may make multiple movements and/or multiple shots to destroy a target. Speed may be measured as the median movement speed for each of the first movements toward each target (e.g., as opposed to the use of movements toward each target subsequent to the first movement). Variability may be measured as the variability of the movement landing points for the first movements toward each target (e.g., as opposed to the use of movements toward each target subsequent to the first movement). Speed may be measured as the shot speed (e.g., 1 over median elapsed time between target appearance and shot fired) for the first shot toward each target (e.g., as opposed to the use of shots subsequent to the first shot). Variability may be measured as the variability of the first shot to each target (e.g. as opposed to the use of shots subsequent to the first shot).

In some embodiments of the present invention, flicking skill assessment (FSA) may be calculated as a performance metric, which may be a robust and sensitive measure to assess and compare skill between players and to track improvement over time of a player's skill as they continue to train and practice.

Some embodiments characterize fine-grained kinematics of players' movements: speed, precision, accuracy, reaction time (SPAR), and swipiness (e.g., tendency to shoot while in motion rather than landing on a target before shooting).

Some embodiments for measuring motor acuity and movement kinematics performance metrics were validated by collecting and analyzing performance data from professional and amateur esports players. The results of this analysis revealed that: 1) movement kinematics depended on task demands (e.g., reaction time was shorter, and movements were less precise and more “swipy”, for tasks that incentivized speed over precision); and 2) individual differences in motor acuity were highly correlated with both movement efficiency (number of movements needed to hit a target) and movement kinematics (reaction time, precision, and swipiness).

Embodiments of the present invention include methods to measure and characterize ballistic or other movements, for example during FPS game scenarios. Ballistic movements may be planned then executed without making any adjustment during the movement, and without using sensory feedback, so the movement is as fast as possible; this is in contrast to some human movements that are made more slowly, using sensory (e.g., visual or tactile) feedback to fine tune the movement while making the movement.

Human performance, e.g. motor acuity, exhibits a speed-accuracy tradeoff: the speed at which a response or action is made is negatively correlated with the accuracy or precision of that action. People can be very fast and less accurate, very accurate and slow, or somewhere in between. This effect can be evident for different aspects of speed (e.g., reaction time, movement speed) and different aspects of accuracy (e.g., percent of correct responses/decisions, movement accuracy and variability). A hallmark of speed-accuracy tradeoff or relationship is the ability of humans to adapt to current demands and prioritize speed and accuracy relative to each other. If a task requires very fast responses or movements, a person may sacrifice accuracy to maximize speed. If there is a high cost to incorrect responses, a person may take longer to respond or move more slowly to maximize accuracy.

In FPS performance, speed-accuracy tradeoff or relationship can be characterized in terms of the movement kinematics performance metrics (e.g., reaction time to initiate a movement, movement speed, movement accuracy, variability or precision of a plurality of movements). Speed-accuracy tradeoff can be characterized also in terms of shot performance metrics (e.g., the time interval between when a target appears and when the first shot is fired and the spatial error of shots). Embodiments may use performance metrics computed based on shot performance. Some embodiments may include or evaluate movement kinematics performance metrics. Differences in flicking skill—and resulting placement of speed-accuracy tradeoff curves—arise between players of different individual skill, as well as within players as they learn and improve or perform under different conditions.

Performance on a single task with a single incentive for speed vs. accuracy may be insufficient to estimate a player's motor acuity or FSA metric, as the speed-accuracy tradeoff cannot be characterized from a single data point. It may be necessary to assess performance in a number of different conditions with different priorities of speed and accuracy. Embodiments may isolate an individual player's skill from their chosen trade-off between speed and accuracy, and hence may represent a sensitive measure of skill differences and improvements rather than bias or strategy.

Some embodiments use products or systems such as Aim Lab systems, an FPS video game. Aim Lab's systems include a large number of tasks that replicate gaming scenarios.

In addition to typical flick- and-land movements, players sometimes choose to maximize speed by shooting “on the fly” instead of slowing down before firing, a tactic referred to as a “swipe” movement. For swipes, the endpoint of the movement may be well past the target location. Some embodiments characterize whether movements more closely resemble a typical swipe versus a typical flick- and-land movement. There is a continuum of “swipiness” with the ideal flick- and-land and the ideal swipe corresponding to two ends of the continuum. In the process of validating an embodiment using an FSA metric, it was found that movement kinematics depend on task demands: reaction time is shorter, and movements are less precise and more “swipy”, for a task that incentivizes speed over precision.

In one embodiment an FSA metric may improve evaluation technology by providing highly sensitive and robust estimates of motor acuity performance. Motor acuity is the ability to execute actions more precisely, and/or within a shorter amount of time. There is a paucity of studies examining motor acuity, a gap likely linked to the tight resource constraints on laboratory-based studies. The handful of lab studies that examine motor acuity have used relatively simple motor tasks, like drawing circles as fast as possible within a predefined boundary, throwing darts, or center-out reaching and grasping.

Embodiments of the invention may evaluate performance based on data produced by a player playing games or gamified tasks such as Aim Lab products (e.g. Sixshot, Gridshot or Adaptive Reflexshot tasks); or other tasks such as tasks specifically designed for therapy. In order to develop one embodiment, a large sample of Aim Lab data (over 7,000 players and over 60,000 repeats of the 60-second Gridshot task) over a period of months was used to examine motor learning. In this database, hits per second was used as a proxy for motor acuity. Embodiments of the present invention may instead use an FSA metric for measuring motor acuity in FPS games.

Aim Lab software systems include commercial software products written in the C# programming language using the Unity game engine. Unity is a cross-platform video game engine used for developing digital games for computers, mobile devices, and gaming consoles. Players may download an Aim Lab system, e.g. to their desktop, laptop or PC, etc. While Aim Lab systems are one example of systems that may be used with embodiments of the present invention, other systems may be used.

Players may control their virtual weapon or other virtual tool in Aim Lab tasks using input devices or controllers such as a mouse and keyboard while viewing the game on a computer screen. Performance data or measurements of user's performance may be uploaded to Aim Lab secure servers. Aim Lab systems includes a large number of different task scenarios for skill assessment and training, each tailored to a facet of FPS play. These task scenarios may assess and train users in the areas of, for example, visual detection, motor control, tracking moving targets, auditory spatial localization, change detection, working memory capacity, cognitive control, divided attention, and decision making. Each task can be customized to prioritize accuracy, speed, and other basic components of performance. During a round, players may be granted points for each target that they successfully shoot and destroy. In some tasks, additional points may be rewarded for targets destroyed more quickly. Players attempt to maximize their score on each round by destroying as many targets as possible. Different task scenarios may incentivize players to prioritize accuracy over speed or to prioritize speed over accuracy.

Player input may include manipulation of the input device (e.g. mouse, Wii controller) to move a player, or move a player's aim (or the aim of a weapon), or the view of the player; and also trigger or shot input to fire a device; and also input to move the player in a game. For example a user may move a mouse to alter the aim of the player, and click on a mouse button to fire a weapon in a game. Measures of speed, precision, accuracy, swipiness, etc. may be based on the relationship between game entities (e.g. targets, player point of views (POVs), the aim of a weapon), the movement of these entities (e.g. the aim of a weapon moving, a target moving), and the timing of entity actions (e.g. a weapon firing, a target appearing, etc.). For example, the accuracy of a shot triggered by user input to a mouse or game controller may be determined by the point of aim (e.g. crosshairs) at the time of the shot, relative to the point or position of the intended target. A user may move their avatar or player by, for example keyboard input (e.g. the known arrow key or WASD input method), which in turn may affect the game entity of the player's point of view, which is often in FPS games coextensive with the entity of the crosshairs or aim of the virtual weapon. The player may use the input device to aim the weapon, which typically means targeting, or aiming or rotating the POV, and may provide trigger input to the input device to fire the weapon. Other methods of user input may be used. The trajectory or movement of targeting, or the aiming or crosshairs may be used to measure player movement kinematics performance metrics (e.g. movement speed, movement precision, movement accuracy, movement reaction time, or swipiness). The crosshairs or aiming position of the weapon may determine where the shot lands: for example if the crosshairs are pointed at/displayed over the center of the target when the shot is fired, the shot is determined to be or deemed to be at the center of the target.

Some embodiments of the present invention utilize task scenarios that assess flicking skill. Flicking may be described as sudden and rapid ballistic movements by a player in a game (both the sudden and rapid motion of the input device and the on-screen movement), for example to aim and fire a weapon to destroy (e.g. stationary or moving) targets. For example, embodiments utilize flicking tasks with different target types (e.g. sizes and/or different target presentation durations), to characterize each player's speed-accuracy trade-off and to estimate their flicking skill.

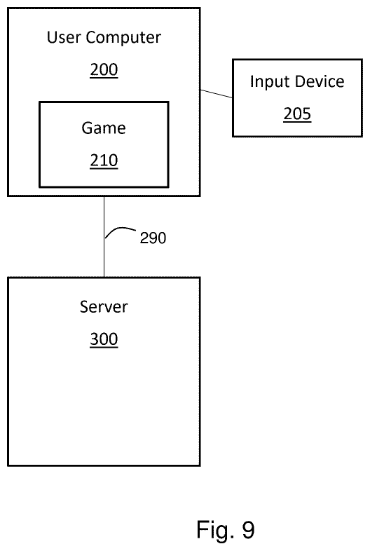

In some embodiments, human participants or players play FPS task(s) remotely using their own gaming set-up. A gaming set-up may include for example hardware such as a PC, or other computer, monitor, mouse and mouse pad, and may operate based on settings (e.g., stored at user computer 200, FIG. 9 or another computer) such as display size, field-of-view, viewing distance, chair height or mouse counts per inch (CPI). There can be a wide range of different equipment combinations across players. In some embodiments, mouse acceleration is disabled. In other embodiments, the tasks are played on a standardized hardware with standardized software settings, for example, in a rehabilitation clinic.

In some embodiments, movement trajectories (e.g., of game entities, objects or on-screen objects such as an aiming point, a weapon, etc.) may be determined by sampling an input position from an input device or controller, controlled by a person while the person plays the game. The input controller can control a number of features of the player, including for example movement of the player, aiming of a player's weapon (e.g. signaled by crosshairs) and/or one or more actions of a player (e.g., utilization of a weapon, such as firing a shot). Examples of input controllers used with some embodiments include keyboard, mouse, gaming mouse, video game console, joystick, accelerometer, gyroscope, pointing device, motion capture, Wii remote controller, eye tracker, computer vision system, an absolute position headset or a six-degree-of-freedom headset such as the Oculus Rift headset from Oculus VR, an inside-out tracking headset (such as the Quest six-degrees-of-freedom, which may track the direction a person looks in as well as the person's position in a room (e.g. using Lighthouse from HTC Vive and Base Stations from Valve Index), or any of a variety of methods, devices, apparatuses, and systems for sensing, measuring or estimating human movement to provide input signals to a computer. For example, the gyroscope in a smart phone or tablet can be used as the input device for games or gamified tasks that run on those devices. Examples of human movements used with some embodiments include hand movements, arm movements, head movements, body movements, and eye movements. Examples of input controllers also include brain-computer interface methods, devices, apparatuses, and systems for sensing, measuring or estimating brain activity. Examples of brain-computer interfaces include, but are not limited to, devices that measure electrophysiogical signals (e.g., using electroencephalography (EEG), magnetoencephalography (MEG), microelectrodes) and optical signals (e.g., using voltage-sensitive dyes, calcium indicators, intrinsic signals, functional near-infrared spectroscopy, etc.). Examples of brain-computer interfaces also include other neuroimaging techniques (e.g., functional magnetic resonance imaging). Examples of input controllers also include methods, devices, apparatuses, or systems for sensing, measuring or estimating physiological data. Physiological data includes, but is not limited to, EEG, electrocardiogram (EKG), electromyography (EMG), electroocoulogram (EOG), pupil size, and biomechanical data relating to breathing and/or respiration. A person of skill in the art recognizes that any such input controller or any combination of such input controllers could be used. It is also recognized that other methods, devices, apparatuses, or systems for sensing, measuring or estimating human movement or physiological activity could be substituted for use with some embodiments, including those that have not yet been reduced to practice.

Some embodiments evaluate a user or player (e.g. evaluate a skill such as performance in flicking skill tasks) by having the player participate in or provide input to one or more of games or gamified tasks or computer games, such as a Gridshot task, a Sixshot task, an Adaptive Reflexshot task or other tasks. Data gathered from these tasks may be used to determine performance metrics in the relevant computer game tasks, for example by presenting, in the relevant gamified task, targets of varying types (e.g. varying sizes), gathering data such as variability, precision, accuracy, speed (e.g. time from target presentation to first shot). A person of skill in the art recognizes that any of a wide variety of other tasks can be substituted.

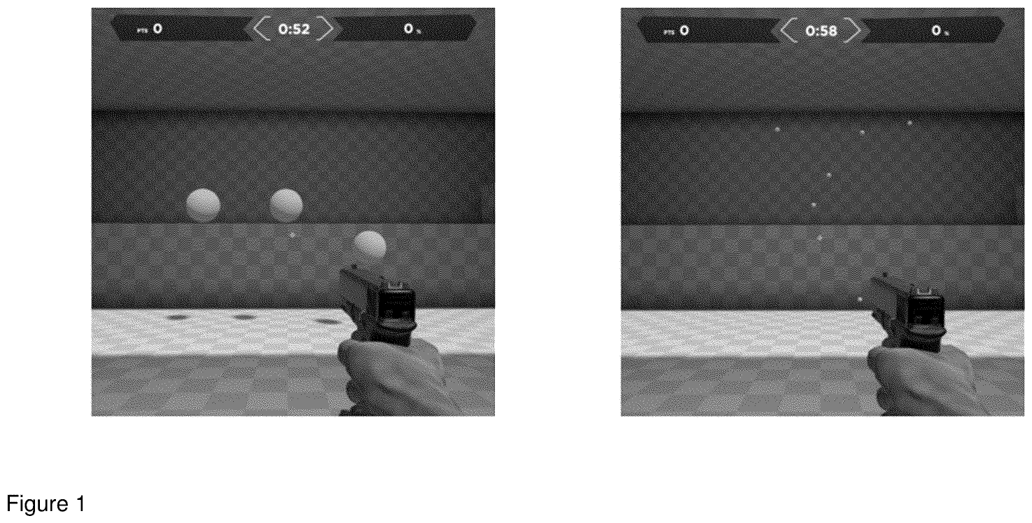

For example, FIG. 1 depicts example screenshots of a Gridshot (left panel) task and a Sixshot (right panel) task, according to some embodiments. Gridshot, Sixshot, and other tasks described herein may measure skills such as flicking skill. In an embodiment using a Gridshot task, targets (e.g. three targets) are presented (e.g. displayed on a monitor) simultaneously, at any given time, with a new target appearing after each target is destroyed. All targets may be the same size, ranging between e.g. 1.3° and 1.7° (degrees of visual angle), assuming a range of viewing distances and a range of values for the field of view in the virtual environment of the game (e.g. set by the player). New target appearance locations may be randomized to for example one of 25 positions in a 5×5 grid, ranging between 4.8° and 9.1° wide and 5.1° and 7.8° high, again depending on viewing distance and field of view. The player destroys a target by manipulating an input device or controller (e.g. moving their mouse) to aim, e.g. to move crosshairs until they are covering some part of the target (preferably some center portion), and then clicking (e.g. the left mouse button) to shoot. Because multiple targets are present at once, combined with unlimited target duration and no explicit incentive to destroy any specific target, the player themself must decide the order in which to destroy the targets. Players receive immediate feedback upon target destruction: for example an explosion sound is emitted, and the orb-shaped target splinters into multiple pieces and then disappears. Players receive summary feedback after each e.g. 60-second round of Gridshot, including score, hits per second (number of targets successfully destroyed per second), and hit rate (percentage of shot attempts that successfully hit a target). Points are added to the score when targets are hit and subtracted for shots that miss a target, and score is displayed at the top of the screen throughout the round. Performance metrics may be automatically calculated in the game's software, e.g., written using Unity software development tools, and displayed to the player as well as sent to a secure server. The number of points added for each target hit may be scaled by time since the previous target hit. That is, more points may be added when the time from the previous hit is shorter. Thus, players are incentivized to shoot targets rapidly and to quickly plan their next movement and shot. While players may be shown multiple performance metrics at the end of each round of play, it is likely that they are consciously optimizing for increased score. Performance metrics such as precision and speed may be computed and collected for a player and used to compute skill.

Performance metrics or data may be gathered from a player's use of a Sixshot task (an example of which is shown in FIG. 1, right panel). The Sixshot task is very similar to Gridshot, with identical possible target locations, but with the following differences: six targets are present at a time, and targets are approximately 14% the size of Gridshot targets. The small target size requires much greater shot accuracy and precision.

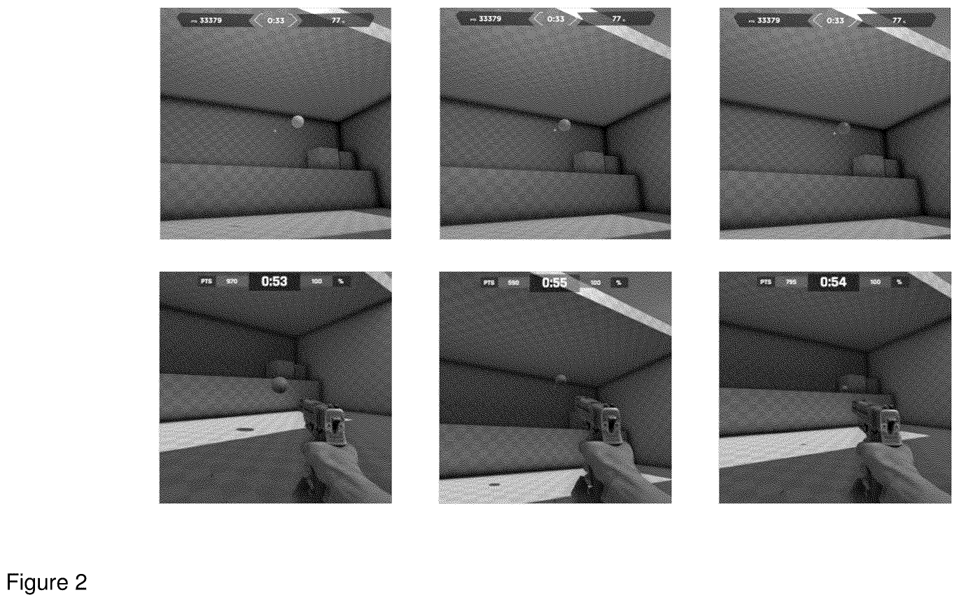

Performance metrics or data may be gathered from a player's use of a task which presents the user with a plurality of target types (e.g. sizes, and/or target presentation durations, or other types), with the target size and/or duration adjusted adaptively to match the player's performance at any given time point. Adaptive Reflexshot (an example of which is shown in FIG. 2) is an example of such a task. One target at a time appears in a randomized location, confined to a (e.g., elliptical) region in front of the player's virtual avatar. Players have a limited time to destroy each target before it “times-out” and disappears. If the target times-out then no points are awarded to the player for that target. To provide a visual cue of time remaining, each target gradually becomes more transparent and then disappears. This motivates the players to be as fast as possible. The three panels in the top row of FIG. 2 show a time series of screenshots as the target becomes progressively more transparent. The three panels in the bottom row of FIG. 2 show examples of three different target types or sizes. In some embodiments, the target presentation duration is titrated according to performance: for example the duration is decreased (it becomes transparent more quickly) on the next trial after a target is destroyed and the duration is increased (it becomes transparent more slowly) on the next trial after a target time-out. In some embodiments, target size is varied from one round of the task to the next, and target duration is titrated separately for each target size. In some embodiments, different target sizes are interleaved within each round of play, and target duration is titrated separately for each target size. In other embodiments the target size is titrated within each round of play: target size is decreased on the next trial after a target is destroyed and the target size is increased on the next trial after a target time-out. In some embodiments target duration is constant during each round, target duration is varied from one round of the task to the next, and target size is titrated during each round. In some embodiments, different target durations are interleaved within each round of play, and target size is titrated separately for each target duration. In some embodiments, both different target durations and different target sizes are interleaved within each round of play, and both target size and target duration are titrated from one trial to the next, based on whether or not the player destroyed the target. In embodiments of the Adaptive Reflexshot task, players are incentivized to adjust their speed and accuracy, depending on target size and duration, so as to maximize their score.

### Movement Kinematics Performance Metrics

Some embodiments may evaluate performance based on movement kinematics performance metrics such as movement amplitude, movement speed, accuracy of movement landing point, variability or precision of movement landing point, reaction time between target appearance and initiation of the movement and swipiness. Various measures of speed, accuracy, variability or precision of movements, and other values based on movement kinematics, may be used in different embodiments. Some embodiments may analyze movement kinematics, and for example fit parametric functions to the time series of each player's movements.

Some embodiments measure movement kinematics of each player for one or more tasks. Players often aim for a target by initiating a movement toward the target, increasing and then decreasing movement speed, and firing a shot after slowing down or coming to a full stop. In some embodiments, the kinematics of these movements are characterized by fitting a sigmoid to the movement time-series. The best-fit parameter values indicate or are a measure of movement accuracy (e.g. amplitude of the sigmoid), movement speed (e.g., slope of the sigmoid), movement precision (e.g., 1 over (divided by) the median absolute difference between the sigmoid endpoint of the movement and the target (e.g. center of the target, an edge of the target, etc.), for a plurality of movements), and reaction time (e.g., time point at which the sigmoidal movement was initiated).

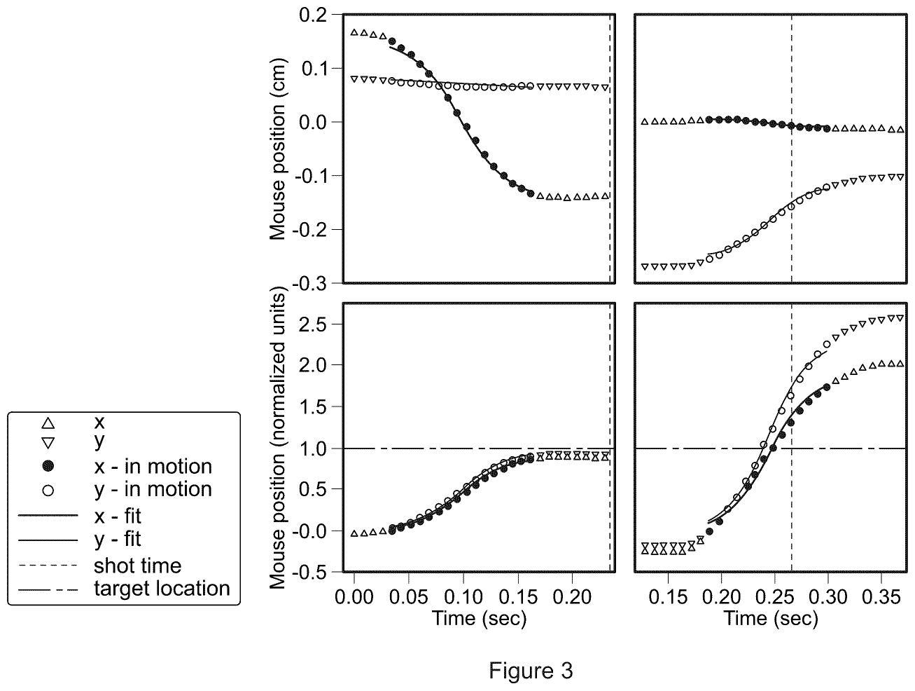

For example, player orientation (e.g. orientation of crosshairs or weapon) during each period labeled as “in-motion” (e.g., by movement parsing) may be fit with a sigmoidal function, for example:

$$f ( t ; a , b , c ) = \frac{a}{1 + {e}^{b} ( t - c )} \qquad ( equation 1 )$$

$$x ( t ) = f ( t ; {p}_{1} , {p}_{3} , {p}_{4} ) \qquad ( equation 2 )$$

$$y ( t ) = f ( t ; {p}_{2} , {p}_{3} , {p}_{4} ) \qquad ( equation 3 )$$

where example Equation 1 defines a sigmoidal function. In this function a, b, and c are the parameters of the sigmoid that determine the lift off (which indicates reaction time), the slope (which indicates speed), and the amplitude (which indicates accuracy). The values of x(t) in example Equation 2 represent a model of the horizontal component (rotation about the y-axis) of the movement trajectory for each time sample, where p1 becomes a, p3 becomes b, and p4 becomes c. The values of y(t) in example Equation 3 represent a model of the vertical component (rotation about the x-axis) of the movement trajectory. Example illustrations of the model components x(t) and y(t) are shown in FIG. 3. The top row of FIG. 3 shows two example movements in units of centimeters, transformed using the input controller (a mouse in this example) calibration. The bottom row of FIG. 3 shows the same two example movements, scaled to normalized units so that 1 corresponds to the target location. The left column of FIG. 3 shows an example of a flick- and-land. The shot (vertical dashed line) occurs after the movement ends and the movement lands at the target location (horizontal dotted line). The right column of FIG. 3 shows an example of a swipe. The shot (vertical dashed line) occurs during the middle of the movement and the movement lands well past the target location (horizontal dot-dash line). In this figure, the time series of x- and y-mouse positions from each trial were normalized, e.g., divided by the x- and y-components of target location, respectively. The values of the parameters (p1, p2, p3, p4) may be fit to each individual movement trajectory, e.g., using the Levenberg-Marquardt algorithm. The circles in FIG. 3 represent samples of the player's movement trajectory. The curves in FIG. 3 represent models of the movement trajectories, as expressed by Equations 1, 2, and 3, with best-fit values for the parameters. In Equations 2 and 3, the x- and y-components of movement are fit with shared parameters p3 and p4. In other embodiments, the x- and y-components are fit independently with no shared parameters, such that midpoint and speed of the x- and y-components can be different from one another.

Accuracy may be how close a given set of measurements (observations or readings) are to their true value, while precision may be how close the measurements are to each other. Precision may be a measure of the consistency with which a player performs: e.g. a player consistently landing a shot a certain distance to a target indicates precision, while a player sometimes landing a shot close to and sometimes far from a target indicates less precision. Accuracy, on the other hand, may measure how close to a target a player's shots hit (e.g., on average): systemically being close to a target indicates high accuracy and systemically landing shots far from a target indicates lower accuracy.

In some embodiments, speed, accuracy, and reaction time may be calculated from, or measured based on, the best-fit parameter values, for example:
1. Speed (e.g., cm/sec or deg/sec): peak speed at the midpoint of the movement, e.g. the movement of the user-controlled game entity such as the weapon, aiming point, or crosshairs.
2. Accuracy (e.g., % distance of the landing point of the movement to the target): which may be described as distance (e.g. spatial error) between the landing location of the movement and the center of the target. For example if a 20 degree movement is required but the player moves 18 degrees then the accuracy is −10% (10% short of the target) whereas if the player moves 22 degrees then the accuracy is +10% (10% past the target). Distance may be measured in e.g. an angle, pixels, a virtual distance having meaning in the reality displayed in the game, actual distance of an input controller to the distance of that controller corresponding to a target (e.g., mouse position on the mouse pad), or other measures.
3. Reaction time (e.g., sec): time interval between when the target appeared and the initiation of the movement (e.g., when the movement reached 5% of its endpoint).

Movement speed and accuracy of each parsed movement or a set of parsed movements can be quantified as for example:

$$Speed = \frac{{a}_{m}}{{f}^{′} ( {p}_{4} ; {a}_{m} , {p}_{3} , {p}_{4} )} \qquad ( equation 4 )$$

$$Accuracy = \frac{{e}^{T} u}{{a}_{c}} \qquad ( equation 5 )$$

$${f}^{′} ( t ; a , b , c ) = b c [ f ( t ; 1 , b , c ] [ 1 - f ( t , 1 , b , c ) ] \qquad ( equation 6 )$$

$${a}_{m} = \sqrt{{( {p}_{1} )}^{2} + {( {p}_{2} )}^{2}} \qquad ( equation 7 )$$

$${a}_{t} = \sqrt{{( {x}_{t} )}^{2} + {( {y}_{t} )}^{2}} \qquad ( equation 8 )$$

$$e = ( {p}_{1} - {x}_{t} , {p}_{2} - {y}_{t} ) \qquad ( equation 9 )$$

$$u = \frac{( {x}_{t} , {y}_{t} )}{‖ ( {x}_{t} , {y}_{t} ) ‖} \qquad ( equation 10 )$$

The position of the player (e.g. the position of the crosshairs) at time t is represented as xₜ and yₜ. The function f′(t) is the derivative of the sigmoidal function (Equation 6). The value of aₘ represents the amplitude of the movement (Equation 7) and the value of aₜ represents the distance to the target location (Equation 8). The vector e represents the movement error (Equation 9) and the vector u represents a unit vector in the direction of the target location (Equation 10). In some embodiments, accuracy is calibrated to have units of cm and/or movement speed is calibrated to have units of cm/sec. In some embodiments, accuracy is calibrated to have units of deg (e.g., angular degrees of rotation in the virtual environment of the game) and/or movement speed is calibrated to have units of deg/sec.

Other units, and other ways of calculating speed, accuracy, and reaction time, may be used. Speed, accuracy, and reaction time may be measured based on multiple movements, e.g., by computing the average or median across a plurality of movements.

Movement precision may be computed as 1 divided by movement variability. Movement variability may be computed as the standard deviation (across a plurality of movements) of movement landing points. Movement variability may instead be computed as the median (across a plurality of movements) of the absolute value of the spatial error (e.g., distance between the movement landing point and the center of the target). Variability may be expressed in units of % distance and precision may be expressed in units of 1/% distance. Other measures of variability may be used instead of standard deviation and median absolute error and variability may be expressed in units other than percentages (e.g., angular degrees, centimeters).

To characterize “swipiness”, the degree to which each ballistic movement resembles a swipe (e.g. shooting on the fly) versus a flick- and-land (e.g. slowing down and stopping before firing) movement, some embodiments compare the time of each shot with the time of the midpoint of the corresponding ballistic movement. An ideal swipe corresponds to firing a shot at the midpoint of a movement, e.g., the time point with maximum speed. An ideal flick- and-land corresponds to firing a shot only after the movement has ended, after the midpoint of the movement. Some embodiments compute swipiness as a ratio of the time of the shot and the time of the midpoint of the movement (p4), divided by 2. This results in a “swipiness” value of 0.5 (example arbitrary units) for an ideal swipe, and a “swipiness” value more than or equal to 1 for an ideal flick- and-land. Other thresholds, and other formulas, may be used. In these embodiments, there is no swipiness value computed for a movement with no associated shot, e.g., if there is no shot between the initiation of one movement and the initiation of the next movement. Swipiness is a granular measure of shot speed as it relates to the movement trajectory, with lower swipiness indicating that the firing of a shot occurred earlier in the trajectory. Additionally, the lack of a swipiness value indicates that a movement is not associated with a shot. Moreover, across trials within a certain context or task, the number of movements with no swipiness value reflects the need for players to make multiple movements to destroy any given target.

### Shot Performance Metrics

Embodiments may measure speed, accuracy, or precision of shot performance; other values based on shot performance may be used in different embodiments. Some embodiments operationalize or calculate speed and precision according to the first shot fired at each target. For example, speed can be computed by or be a measure based on: 1) determining the elapsed time between target spawn or appearance and the first shot fired (e.g. an input to fire a shot received from a game controller), separately for each target; 2) computing the mean or median elapsed time for this spawn-shot time across a plurality of targets; and 3) computing 1 divided by that mean or median elapsed time. Likewise, precision can be computed by: 1) computing the shot error of the first shot that was fired at each target (e.g., the distance between the landing point of the shot in the game and the center of the target); 2) computing the mean or median of the absolute value of the shot error across a plurality of targets; and 3) computing 1 divided by that mean or median shot error. Other methods of calculating shot speed, precision or variability, may be used for a plurality of shots.

Distance may be measured at the time a shot is taken. A shot being taken may include that a player provides input to an input device such as a mouse or game controller indicating that the player wants to fire a virtual weapon (e.g. rifle) at a target displayed in a game. Distance may be measured between the landing point of the virtual shot in the game and the center of the target.

### Error, Precision and Variability

Shot performance or movement kinematics may be used to determine precision, variability, or other measures. In some embodiments multiple measures of shots or movement kinematics (typically for a specific target type)—typically error—may be used to calculate precision or variability. For example, multiple measures of error for a metric (e.g. shot error or movement error) may be taken; variability may be computed for this error; and precision may be determined as 1/variability (thus variability may be 1/precision). Error in some embodiments may be absolute value of error, e.g. absolute value of distance between target center and movement or shot landing point, or other error. Precision (e.g. shot precision, movement precision) may be calculated as or be a measure based on, in one embodiment 1 over (divided by) the variability. A person of skill in the art recognizes that there are a variety of alternative ways to compute shot or movement variability. Some embodiments compute shot variability as the standard deviation of shot locations or movement landings, or standard deviation of accuracy over a plurality of movements or shots. Some embodiments instead compute the median absolute deviation (MAD) of measures such as movement or shot accuracy, or the median of the absolute difference from the median. MAD is a robust measure of variability and may minimize the impact of outliers.

Precision or other measurements may be based on one player's multiple shots, movements or trials, or multiple players multiple shots, movements or trials, e.g. in order to compare one newly seen player to multiple other players in a database, or one player against that same player's prior performance. A database may be created of speed, precision or variability, accuracy or error, reaction time and other performance metrics for players (e.g. past players) for comparison to new or future players.

A variety of measures of variability could be used instead of standard deviation or MAD. Some embodiments compute the square-root of the median squared difference from the median of, e.g. shot accuracy or movement landing accuracy, or of squared movement error, square root of the median of the squared deviation, or other player measures. Embodiments compute shot variability based on shot error, e.g., the distance between each shot location and the target center (rather than the mean or median of the shot locations). Embodiments can compute the mean of the movement or shot errors across a plurality of shots or movements, median of the errors, the square-root of the mean, or of the median, of the squared errors, or the square-root of the median of the squared errors. Embodiments may compute movement variability based on movement error, e.g., the distance between the landing point of each movement and the target center (rather than the mean or median of the movement landing points). Embodiments can compute the mean of the movement errors across a plurality of movements, median of the movement errors, the square-root of the mean of the squared movement errors, the square-root of the median of the squared movement errors.

For task scenarios that titrate target size, some embodiments operationalize variability and precision based on a target size threshold. A target size threshold may be computed by for example by: 1) determining for each target the target size (e.g. in pixels on a display; degrees of visual angle; or another measure) and whether or not the target was hit; 2) calculating the hit rate (proportion of targets hit) for each of the possible target sizes; and 3) fitting a parametric function to the resulting hit rates. Some embodiments use a maximum likelihood fitting procedure. Other methods for fitting psychometric data are well-known to a person of skill in the art. A target size threshold may instead be determined as the target size value converged on during titration. Precision can then be computed as 1 divided by the size threshold.

### Speed Measurement

Embodiments may use a variety of ways to compute speed of shots or movement kinematics. Embodiments can compute, or measure speed based on, for example, shot speed (e.g. shots per second), hit rate (e.g., in units of hits per second), movements per time period (e.g. second), mean or median movement speed (e.g., in units of cm per second, degrees per second, pixels per second, etc.), peak movement speed for a parsed movement or a set of parsed movements, the slope of a sigmoid describing a movement, mean or median movement reaction time, mean or median shot time (time interval between target appearance and first shot), or other measures.

For task scenarios that titrate target duration, some embodiments operationalize speed based on a target presentation duration threshold. A target presentation duration threshold may be computed by for example: 1) determining for each target the presentation duration and whether or not the target was hit; 2) calculating the hit rate (e.g., proportion of targets hit) for each of the possible presentation durations; and 3) fitting a parametric function to the resulting hit rates. Some embodiments use a maximum likelihood fitting procedure. Other methods for fitting psychometric data are well-known to a person of skill in the art. A target presentation duration threshold may instead be determined as the target duration value converged on during titration. Speed can then be computed as 1 divided by the duration threshold.

According to some embodiments, speed is operationalized as 1 divided by target presentation duration threshold (speed may be a unitless measure in such embodiments). Shot speed (in example units of 1/seconds) may be compared to a function of the shot error (in example units of degrees) for the Adaptive Reflexshot task with multiple (e.g. three) different target types or sizes. Shot speed may be for example computed from the target presentation duration threshold; and shot error may be for example computed from the distance between the center of a target and the first shot that was fired at that target.

### Movement Parsing

A parsing or other process may segment movement data into individual movements so as to measure movement kinematics such as speed, reaction time, and movement accuracy separately for each individual movement. An individual movement may be defined from the stream of input from a user, for example by parsing.

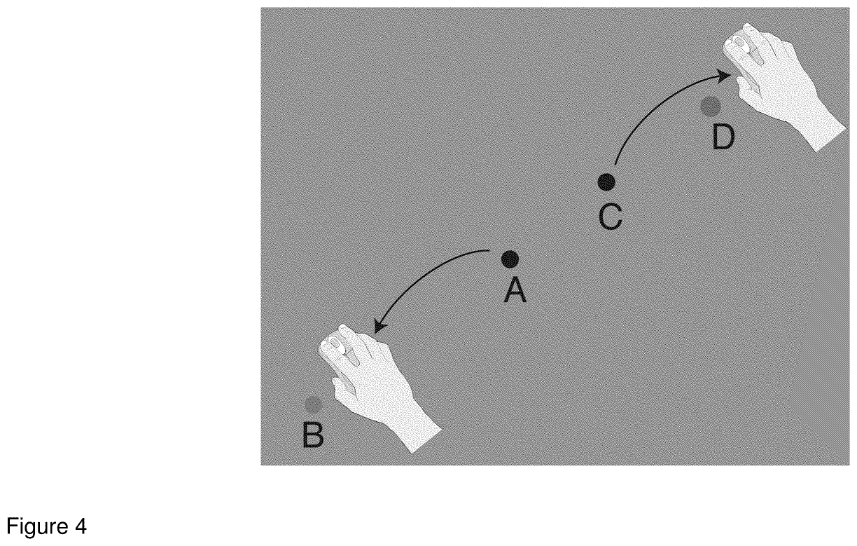

A primary movement of an aiming point, a player, or a player's weapon toward a target is frequently followed by a corrective movement. For instance, the primary movement can be hypermetric, passing beyond the target, with a corrective movement in the opposite direction back toward the target (see example in FIG. 4, C to D). Conversely, the primary movement can instead be hypometric, falling short of the target (see example in FIG. 4, A to B), requiring a corrective movement in the same direction as the primary movement. There are sometimes multiple corrective movements. In some embodiments, a single primary movement can be identified for each target as the largest amplitude movement in the direction of that target (for example, within ±45 degrees). In some embodiments, the different types of movement components (primary versus corrective) can be analyzed separately.

Some embodiments parse the time-series of each player's movements acquired by the input device or controller. This may take as inputs a number of player inputs over time and produce, as an output, a number of distinctly defined movements. Movements can be recorded as change in orientation (e.g., Euler angles) in the virtual environment of the game. Movement parsing may label each time-point as for example in-motion or stationary. Epochs (e.g., periods of time corresponding to a consecutive series of time samples) are labeled as in-motion after one or more consecutive samples exceed a velocity threshold. Epochs are labeled as stationary after one or more consecutive samples fall below a velocity threshold. The number of consecutive samples used and the values of the thresholds can be determined from a large dataset comprising data from a large number of players. Each successive epoch (e.g., in-motion or stationary) may be different in duration.

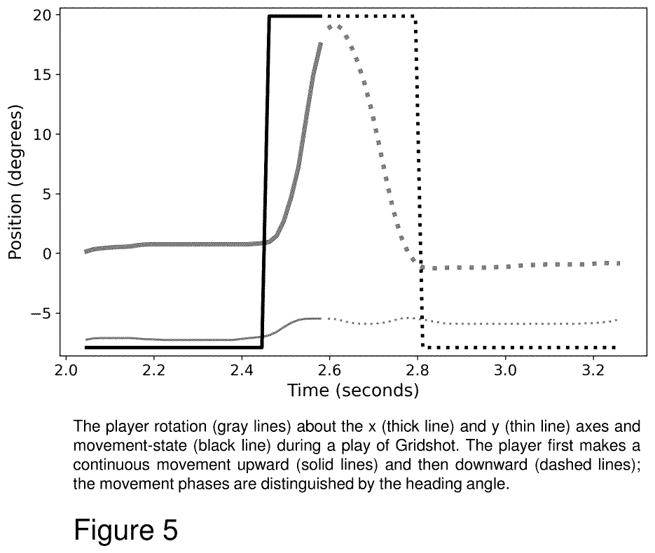

Players may change the direction of their movements without significantly slowing their movement speed. For example, this may occur when multiple targets are present in the virtual environment, and a player begins to move towards one and then decides to prioritize a different target without destroying or shooting at the original target. As another example, a player may not reach a target quickly enough, and thus will never fire a shot at that target even though a ballistic movement was initiated in that target's direction. Some embodiments utilize changes in movement direction to parse movements. If the player moves in one direction and then changes to a substantially different direction, then the time-series may be segmented such that an epoch preceding the change in direction are associated with one movement and the epoch following the change in direction are associated with a different movement. Some embodiments detect a change in direction when the angle of the movement velocity changes above a threshold for one or more consecutive time samples. The number of consecutive samples and the values of the thresholds can be determined from a large dataset comprising data from a large number of players. An example is shown in FIG. 5. The player's orientation is plotted in FIG. 5 in degrees on the y-axis, across time in seconds along the x-axis. The thick and thin lines indicate the x- and y-components, respectively, of the player's orientation. The epoch of time bracketed by the black rectangle indicates the time over which the player's motion had a speed that was fast enough to be considered in-motion. During the time period shown, the player moved in one direction, and then rapidly changed directions without slowing down. The point at which the direction changed is parsed into a separate movement. The solid lines and solid curves correspond to the first of the two movements. The dashed lines and dashed curves correspond to the second of the two movements.

In some embodiments, performance metrics can include the median number corrective movements to hit a target and the proportion of targets for which the player hits the target with N movements (where N is a positive integer).

Some embodiments associate each of a player's movements with a shot. Players typically make a sequence of movements to destroy a target. To associate a shot with one or more movements, some embodiments first identify the time point at which the shot was fired, and step backwards in time (e.g., asses) from the time at which a shot was fired to identify the movements that were initiated at time points preceding that shot. Each shot may be associated with more than one movement. Each movement may be associated with more than one shot. For example, a player may fire a shot that misses the target during an initial swipe movement, followed by a corrective movement and a shot that destroys the target. In this example, the initial swipe movement may be associated with both shots. Some embodiments associate movements with corresponding targets according to which shots are associated with that movement and which target or targets was or were closest to the associated shot or shots.

Performance metrics in some embodiments can include the proportion of movements for which there is no shot associated with the movement, which reflects the need for players to make multiple movements to destroy any given target.

### Input Device Calibration

Data analysis and validation may be performed in varying manners. For example, input controller or device calibration may be performed.

Some embodiments measure the player's physical movements (e.g. the movements of a mouse on a mousepad when the input controller is a computer mouse). To do so, the orientation data of the player as depicted in the game (e.g. the crosshairs) may be converted to the corresponding movements of the mouse on the mouse pad (e.g. the physical movements that were used to generate player movement), e.g. in units of centimeters or inches. This may require additional information about the relationship between physical mouse movement and changes in player orientation, which can vary across players due to their hardware and software settings. Other input devices may be used.

Some embodiments record the in-game settings that govern the field of view as well as the mouse or input device sensitivity, e.g. the magnitude of a change in camera rotation of field of view displayed to a user (which may determine aiming, crosshairs, or a weapon position) that results from a single increment or count from the mouse. Mouse sensitivity can be recorded for the x- and y-axes of motion independently. Additionally, some embodiments record a player's mouse (e.g. hardware, software, or both) settings that determine the number of counts that result for one unit (e.g. inch) of distance traveled (e.g., counts per inch, CPI).

In one embodiment, player camera orientation or aim point (e.g. position of cross hairs over a target) is converted into units (e.g. centimeters) of physical mouse movement, for example according to a formula such as:

$$\begin{matrix}1. Mouse sensitivity * 0.05 = angle increment ( degrees turned per count ) \\ 2. Total degrees turned / angle increment = counts \\ 3. ( counts / CPI ) * 2.54 = physical distance traveled ( cm )\end{matrix}$$

The value of 0.05 is an example constant used in the Unity software code to scale mouse counts to degree increments; other constants, other formulas, and other software tools may be used. In other embodiments the input controllers can be calibrated using similar methods and computations, that distances can be specified in metric units (e.g., centimeters) imperial units (e.g., inches) or other units.

### Data Post Processing

Data post-processing may be performed, e.g. after obtaining data from games or gamified tasks or computer games and, e.g., prior to using the data to evaluate motor acuity or flicking skill. Some embodiments apply one or more steps of post-processing to movement kinematic metrics (e.g. speed, precision, accuracy, reaction time, and swipiness) or shot performance metrics to remove outliers and/or to decorrelate the values. Some embodiments apply an upper and lower band threshold to remove outliers (e.g. presumed to be failures in the trial parsing or sigmoid fits) from the movement kinematic metrics. For example, the lower band threshold can be 0 and the upper band threshold can be and the 95th percentile. In some embodiments, movements are pruned (e.g. ignored from further analysis) if the sigmoid fits are poor, for example with an r-squared (coefficient of determination) value less than 0.5.

In some embodiments, each accuracy value is multiplied by 100, to convert from proportion to percent of the distance to the target. Some embodiments subtract 100 from each accuracy value such that hypometric movements (movements ending short from the target) have negative values and hypermetric (movements ending past the target) have positive values. For example, if movement kinematics are being used, an embodiment may compute the median of each kinematic metric across a plurality of movements, separately for each individual player, and separately for each movement-type (primary versus corrective). Doing so may yield, for example, a total of 10 values for the movement kinematic metrics for each task: 5 kinematic metrics (median speed, MAD precision, median accuracy, median reaction time, and median swipiness) for primary movements and 5 kinematic metrics (median speed, MAD precision, median accuracy, median reaction time, and median swipiness) for corrective movements. Some embodiments compute a z-score (a statistical measurement of distance from a mean or average) for each movement kinematic metric across players. Similar processing may be used for other player data, such as shot performance metrics.

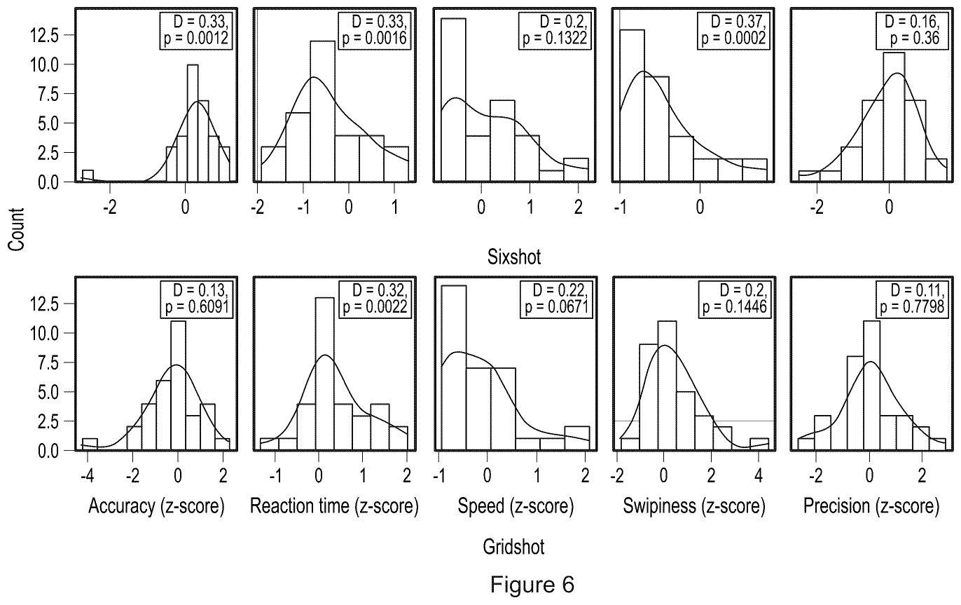

FIG. 6 shows examples of the distributions of movement kinematic metrics for a dataset of 32 professional and semi-professional esports players, each of whom played multiple rounds of the Gridshot and Sixshot tasks. Once z-scored (e.g. using standard deviation calculations), some embodiments test the movement kinematic metrics for normality (e.g., using the Kolmogorov-Smirnov statistical test). The annotation boxes in FIG. 6 show statistical results from the Kolmogorov-Smirnov test for normality: D=KS-statistic and p=p-value; other annotation boxes in FIG. 6 indicate a p-value<0.05. For the example distributions in FIG. 6, the resulting p-values indicated that the majority of kinematic metric distributions were non-normal (p<0.05 for 6 of the 10 distributions). In such cases, non-parametric approaches to statistical analysis may be used, for example, to determine statistically significant differences in movement kinematics between players, between groups of players, or over time.

Some embodiments compare the input controller sensitivities (e.g., mouse sensitivities) with the movement kinematic metrics. To mitigate the confounding effects of the sensitivity of the input controller (e.g., mouse sensitivity), some embodiments regress out sensitivity from the movement kinematics values. An embodiment may correlate between mouse sensitivity and each movement kinematic metric for the primary movements, e.g. from a dataset of 32 pro and semi-pro esports players, using, e.g. a Gridshot task and a Sixshot task. An embodiment may use statistical results from Spearman's Rank Correlation (e.g. rho=Spearman's Correlation Coefficient and p=p-value; e.g. using p-value<0.05).

An embodiment may use residual correlations after z-scoring the movement kinematic metrics across players and regressing out mouse sensitivity from the movement kinematic metrics. Mou7se sensitivity may be correlated with movement reaction time, movement speed, swipiness and other performance metrics. The correlation may be removed by the regression procedure. Embodiments may use correlations, before and after z-scoring and regressing out mouse sensitivity, respectively, for corrective movements.

An example regression operation includes Equations 11 through to 13 in order. Firstly, the pseudo-inverse of the mouse sensitivity array a^{#} may be calculated and multiplied by the matrix of z-scored kinematic metrics Y to produce the estimate \hat{x}:

$$\hat{x} = {a}^{\#} Y \qquad ( 11 )$$

Subsequently, an embodiment may compute the estimate Ŷ by multiplying \hat{x} with the z-scored mouse sensitivity array A:

$$\hat{Y} = A \hat{x} \qquad ( 12 )$$

where subtracting Y\hat{ } from y gives the residuals (E) of the kinematic performance matrix:

$$E = Y - \hat{Y} \qquad ( 13 )$$

### Adjustment of Input Evaluation

Some embodiments may dynamically manipulate or adjust the evaluation or mapping of input signals from an input device, for example for therapy or to train a player to adjust their movements of the input device accordingly. The relationship between an input received from a player or patient via a controller, or computer input device and the movement of a virtual object within the virtual environment of the game may be changed, reset, modified or adjusted based on the performance metric. For example, if mouse input of a certain unit is to move an on-screen object or perspective by a second unit, the ratio of movement by the second unit to the first unit may be changed as a result of a performance metric or motor acuity. In one embodiment, a player's performance is improved by using a motor adaptation protocol to train the player to make faster and/or more accurate movements. In one embodiment, the mapping from mouse position to screen position is adjusted dynamically during training or therapy. For example, if a player's movement to a particular target location is hypometric then the mouse movements toward targets at that location are remapped so as to make the movement more hypometric. The player can then automatically learn to compensate for such changes, leading to improved performance accuracy. Other embodiments include manipulating the position, velocity, acceleration, or higher-order temporal derivatives of position acquired with one of the input controllers. Other embodiments include manipulating the orientation, angular velocity, angular acceleration, or higher-order temporal derivatives of orientation acquired with one of the input controllers. Other embodiments include manipulating the joint angle, angular velocity of joint angle, angular acceleration of joint angle, or higher-order temporal derivatives of joint angle acquired with one of the input controllers.

Manipulating the relationship between controller input or the persons' movements and their interaction with the virtual environment may be designed to improve the persons' performance.

The manipulation of the relationship or mapping between the persons' movements and their interaction with the virtual environment, or the objects displayed, may include manipulating at least one of position, velocity, acceleration, higher-order temporal derivatives of the position, orientation, angular velocity, angular acceleration, higher-order temporal derivatives of orientation, joint angle, angular velocity of joint angle, angular acceleration of joint angle, and higher-order temporal derivatives of joint angle.

Manipulating a relationship or mapping between input and on-screen movement may include setting or altering the sensitivity of an input controller (e.g., the mouse sensitivity); this may be in response to a performance metric or for example to correct for biases in a player's movements. In one example embodiment, a player may make a series movements from each of a plurality of starting positions to each of a plurality of target positions. The position error (e.g., the amplitude and direction of the difference between the landing position of the movement and the position of the target) is measured for each movement, and the average movement error is computed for each combination of a starting position and a target position. The computer program then manipulates the sensitivity of the input controller to correct for systematic biases in the player's movements.

In some embodiments, various parameters of the input controller may be manipulated or adjusted including, for example, the acceleration of the input controller, different sensitivity parameters for different movement directions, DPI (dots per inch, a measure of how many pixels on-screen an object moves for each unit of input controller movement), lift-off distance, polling rate, button response/debounce time, and angle tuning. A relationship may be adjusted defining sensitivities of the computer input device or dots-per-inch moved by the virtual object for each unit of movement of the computer input device. In one embodiment, input controller settings or sensitivity may be adjusted for certain directions of input controller movement. For example, a sensitivity may be adjusted only for vertical, horizontal, left, up, down, or a certain degree (e.g. when measured using a 360 degree definition of direction) of direction. Different sensitivity adjustments may be made for each of a number of different movement directions. A parametric definition of sensitivity may, using parameters describing a direction of motion (e.g. degree), define different sensitivities for different directions.

Embodiments may utilize different performance metrics for determining the manipulation or adjustment of a relationship between input and on-screen movement including, for example, score, movement kinematic performance metrics, shot performance metrics, motor acuity, or another player performance metric.

The adjustment in sensitivity, mapping or a relationship may be done in software, e.g. in the game software; or for example by adjusting input controller or mouse settings, or hardware settings.

### Flicking-Skill Assessment

Performance, e.g. motor acuity, may be is determined based on one of the speed performance metrics and one of the variability (or precision) performance metrics, optionally with one or more of the pre-processing steps and post-processing steps. Embodiments may measure a flicking skill assessment (FSA) or motor acuity using a speed-accuracy tradeoff. A statistical analysis or graph may compare shot speed as a function of the median shot variability for, e.g., Gridshot and Sixshot tasks. One or more players assessed may follow the expected pattern in behavior: lower precision and faster speed in Gridshot compared to Sixshot. This demonstrates that players respond strategically and appropriately to the different demands of the two tasks. Lines may be plotted each of which connects the multiple (e.g., two) data points from one single player corresponding to the multiple (e.g., two) tasks. After plotting or analysis, the resulting plot or analysis may be re-plotted or analyzed in terms of shot precision (e.g. a measure being 1 over or divided by shot variability). The resulting curves may represent the transformed lines from the first analysis or plot. A diagonal dashed line or other plot may be plotted from the origin (0,0) to three times the standard deviation plus the mean of the distribution of shot precision (x-axis) and shot speed (y-axis) across all players. In some embodiments, the intersection of individual curves with the diagonal may indicate flicking skill. Some embodiments obtain a flicking skill value for a player, by identifying the point along the diagonal line that intersects with that player's speed-accuracy tradeoff curve; in some embodiments arbitrary skill units may be assigned to the relative position of the intersection or distance of the intersection from the origin. This relative skill may be player vs. other player(s); or player vs. performance of that same player at another time. Speed-accuracy tradeoff curves located towards the upper right indicate better performance, e.g., higher precision and faster speed. Notably, as demonstrated elsewhere herein, these flicking skill values are related to certain aspects of movement kinematics; movement kinematics may provide details as to the basis for specific differences in skill between players. A diagonal line drawn through each player's speed-accuracy tradeoff curve may rank each player such that, e.g., the speed-accuracy tradeoff curves further from the origin associated with players having higher measured skill. Such an embodiment may compare motor acuity values across players to determine which player has better skill; over time (for an individual player) to characterize that player's improvement over time; or across conditions, e.g., hardware, software, and various other factors (e.g., mouse, mouse pad, rendering latency, posture, exercise, diet and dietary supplements, sleep, etc.), for a group of players or for an individual player, to determine the impact of these factors on performance (e.g., to show that a new gaming mouse is better than a competing product).

In one embodiment, FSA is computed as the value along a diagonal or other plot or line that intersects a player's speed-accuracy tradeoff curve. There are a variety of ways to compute this flicking skill value. For example, in one embodiment the diagonal line is transformed back to the shot speed vs. shot error plot and the intersection could be found there; the diagonal may be a scale line indicating skill. In one embodiment a mathematical formula is used to find the intersection. In embodiments a line with different slope is used, or the x- and/or y-axes are rescaled.

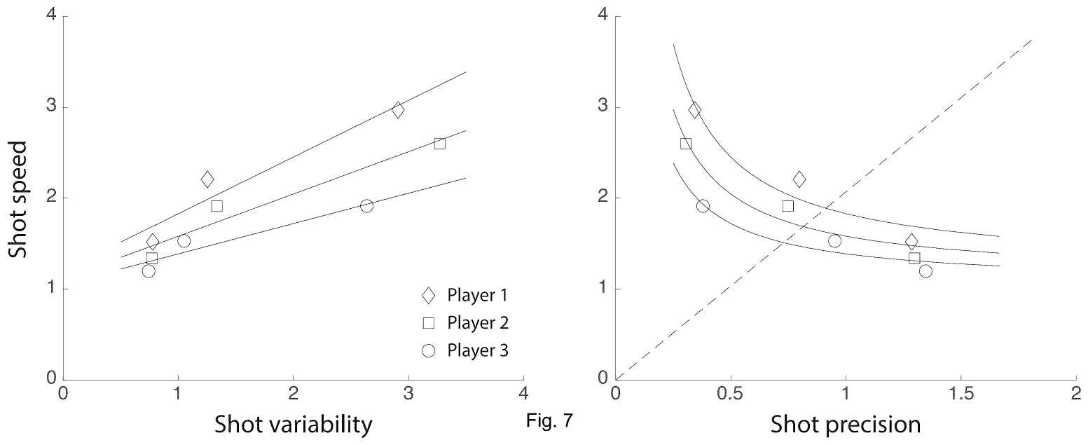

FIG. 7 shows an example of FSA, utilizing time between target spawn and the first shot fired and shot variability of the first shot that was fired, for a plurality of targets, according to some embodiments. In FIG. 7 the Y axis represents speed, and the X axes represent variability and precision, respectively. In another embodiment, curves similar to those on the right side of FIG. 7 may be created or plotted which represent a relationship or comparison between speed and accuracy for different target types or sizes. In FIG. 7 shot speed and shot variability are analyzed, but the method described with respect to FIG. 7 may be used for other performance metrics such as movement kinematics performance metrics. Typically the speed, variability and precision are of the same type of performance metric: e.g. shot performance metrics (as in the example of FIG. 7), movement kinematic metrics, or another type of performance metric. However, in other embodiments, speed may be speed of a first measure (e.g. shot speed) and both variabilty and precision may be of another measure (e.g. movement precision). Some embodiments define the axis of performance or flicking skill as a line from the origin (0,0) to a multiple of (e.g., three times) the standard deviation plus the mean of the distribution of precision (x-axis) and speed (y-axis) across all players. FIG. 7 illustrates an example of speed-accuracy tradeoff curves this for three players (other numbers of players may be used), and the dashed line in the right side of FIG. 7 illustrates an example of an axis of flicking. In some embodiments, the intersection of individual curves with the diagonal, which may be a performance scale, indicates flicking skill. In the example of FIG. 7, the player represented by the diamond-shaped plot symbols has the best flicking skill and the player represented by the circular plot symbols has the worse flicking skill. In other embodiments, there are alternatives for defining the axis of flicking skill.

Typically, for each individual data point (e.g. shot, movement, etc.), from multiple error measurements in a session (e.g. a game, or a gamification trial) variability is determined (e.g. based on standard deviation or other calculations), and a data plot or point (such as one of the diamonds, shapes or squares on the left graph in FIG. 7) is created for one player for that trial, game, or other period, representing that variability. Typically each plot represented by a shape is for a certain target type (e.g. size), and a line is drawn through plots of different target types. A line is drawn for each player and session, and the inverse plot is created from this line to graph precision, as on the right side of FIG. 7. In some embodiments, for one or more players providing input to a game or gamified tasks, speed (e.g. shot speed, movement speed, etc.) may be analyzed (e.g. using statistical analysis) or plotted relative to variability (e.g., shot variability, movement variability, etc.), for at least two target types or sizes per player. In one embodiment a database is created for past performance related data for many players. For example, for each of many thousands of movements and shots data regarding speed, accuracy, variability, precision, etc. may be collected.

For example, for each player one line (e.g., a best fit line) may be drawn through the multiple target type graph plots for that player; to get one line per player. The left panel of FIG. 7 shows shot speed (in units of 1/seconds) as a function of or in relationship to the shot variability (in units of degrees) for the Adaptive Reflexshot task with three different target sizes and three different players. Shot speed may be computed as the median across the plurality of targets of the elapsed time between the time sample at which a target was spawned and the time interval at which the first shot was fired at that target. Shot variability may be computed as the median across the plurality of targets of the distance between the center of a target and the first shot that was fired at that target. For each player, the player symbol on the left side of the left graph of FIG. 7 is the plot for a small target size, the next player symbol to the right along the direction of the X axis indicates an intermediate target size, and the player symbol on the right of the left graph is the plot for a large target size, larger than the that of the two symbols to the left (in this example each player is assessed based on three target types or sizes). While three different sizes are shown, other embodiments may use other numbers greater than one. Each line in the left graph is a best fit line to the data from one player, e.g. of shot speed related to shot variability of the player or player input.

The right panel of FIG. 7 re-plots these results in terms of shot precision (e.g., 1 over shot variability in units of degrees −1), converting or transforming each line on the left side to a curve on the right side. The curves represent the transformed lines from the left panel showing a relationship or comparison of speed to precision for each player (e.g. shot speed's relationship to shot precision). The dashed diagonal line in the example of FIG. 7 indicates an axis of flicking skill, and the intersection of individual curves with the dashed diagonal line indicates the flicking skill assessment (FSA), a measure of performance or motor acuity for flicking tasks. For example, the further the distance of the curve, or the distance of the intersection with a line, for player X is from the origin, the better the assessed skill, performance or motor acuity for that player. The diagonal line may be a tool or scale to standardize the distance of the curve from the origin. In some embodiments a database of prior players may have speed and precision plotted in this manner, and a newly seen player may have skill compared to the database of prior players by having the newly seen player's speed-accuracy tradeoff curve and flicking skill plotted against that of the prior players, and from this a relative measure of the skill of the new player may be assessed. In some embodiments a numerical scale may be defined for flicking skill such that for example a player of average skill is assigned an FSA value equal to 100, a player that is 1 standard deviation above average is assigned an FSA value of 110, a player that is 2 standard deviations above average is assigned an FSA value of 120, a player that is 1 standard deviation below average is assigned an FSA value of 90, etc.

Some embodiments may rank flicking skill across multiple players, or may rank an individual player's change in flicking skill over time, for example such that the speed versus precision curves intersect the axis of flicking skill (the dashed diagonal line) more towards the upper right (e.g. as speed and precision increase) as the player improves over time.

In some embodiments, the axis of flicking skill (e.g., indicating as the diagonal dashed line in FIG. 7) may extend from the origin (0,0) to three times the standard deviation plus the mean of the distribution of precision (x-axis) and speed (y-axis) across all players. Any suitable measure of central tendency and any measure of spread may be used. Any suitable multiple of the spread may be used instead of three and the multiples for the x- and y-axes may be different from one another. In other embodiments, the axis of flicking skill can be defined in passing through the mean of the speed and precision values, extending plus or minus three times the standard deviation. Again, any measure of central tendency (e.g., median) may be substituted for the mean, any measure of spread may be substituted for the standard deviation (e.g., MAD), and any multiple of the spread may be used instead of three times the standard deviation.

The graphs shown in FIG. 7 need not be generated in some embodiments; rather a statistical analysis may be performed that is an analogue of the shown graphs, e.g. to determine the relative distance along a line of player performance curves from an origin. In other embodiments, a statistical analysis may be performed on the speed and accuracy of the player, e.g. the relationship between speed and accuracy.

An embodiment may perform a multiple linear regression (e.g. on a number of data points, each corresponding to a summary (e.g. average or median) of speed in relationship to precision, accuracy or variability). A statistical analysis may determine if there is a change in performance or motor acuity, e.g. if there is a substantial improvement in speed (e.g., greater than 5%) with no substantial change in variability (e.g., no more than 5%), precision or accuracy, or a substantial improvement in variability, precision or accuracy (e.g., greater than 5%) with no substantial change in speed (e.g., no more than 5%), or a substantial improvement in both speed and accuracy (e.g., greater than 5%). Other measures or thresholds may be used to define or deem a change in motor acuity, e.g. a change in motor acuity may occur if there is a >10% speed improvement with no substantial change in variability, or other combinations of changes with different thresholds. A statistical hypothesis test may be used to determine the value or values that specify whether or not there is a substantial change in speed and/or variability, precision or accuracy to determine if there is a statistically significant change in motor acuity, e.g. if there is a statistically significant improvement in speed with no statistically significant evidence for a change in variability, precision or accuracy, or a statistically significant improvement in precision (or variability or accuracy) with no statistically significant evidence for a change in speed, or a statistically significant improvement in both speed and precision (or variability or accuracy). Such an embodiment may determine if there is a difference in motor acuity across players, across conditions, or over time.

In some embodiments, performance metrics other than precision may be compared to or analyzed in relationship to speed, e.g. accuracy or variability of the player's movements or input to a game. The precision, accuracy, variability or other measure of the player analyzed in relation to speed may be, for example, that of player movement kinematics performance metrics, shot performance metrics, or another player performance metric. Other measures of player speed may be used, for example movement speed, shot speed, or other variations of a speed metrics including a target presentation duration threshold as discussed elsewhere herein. Embodiments using precision as a performance metric, and may use measures of precision such as movement precision, shot precision, or other measures. In one embodiment, a comparison of the motor acuity of two players (or to compare a player with themself over time) includes a statistical analysis of whether the speed increases (over time for a single player) or is larger (comparing different players) with no statistically significant evidence for a change in precision (or vice versa).

In some embodiments movement speed or movement variability (e.g. parsed as described herein) may be used as a measure instead of shot speed or shot variability, since in some FPS tasks player movement has a landing point, or ending of the movement. For some applications, there may be no shot, e.g. a task where the player or user is to aim at the center of a target (e.g., move a crosshair to the middle of a circle), with no click or shot input, but movement can also be a measure in applications where there is a shot. In some FPS tasks, a flick may involve move, stop movement, and shooting; while swiping may include shooting while moving, and in some of these tasks movement alone may be a measure of skill. Speed may be for example, how quickly a trigger is pulled, or a peak or average speed of movement, e.g. mouse movement, movement on a mousepad, movement of degrees of rotation, etc.

Some embodiments test the flicking skill values for normality, and some embodiments use non-parametric approaches to statistical analysis, for example, to determine statistically significant differences in flicking skill between players, between groups of players, or over time.

Some embodiments compare the input controller sensitivities (e.g., mouse sensitivities) with the flicking skill values. To mitigate the confounding effects of the sensitivity of the input controller (e.g., mouse sensitivity), some embodiments regress out sensitivity from the flicking skill values. In one example validation or this, correlations between mouse sensitivity and flicking skill for 32 pro and semi-pro esports players were analyzed. Residual correlations after z-scoring the flicking skill values across players was performed, with regressing out mouse sensitivity from the flicking skill values. In this example, mouse sensitivity was correlated with flicking skill and the correlation was removed by the regression procedure. Statistical analysis was performed with Spearman's Rank Correlation: rho =Spearman's Correlation Coefficient and p=p-value; an example p-value being <0.05.

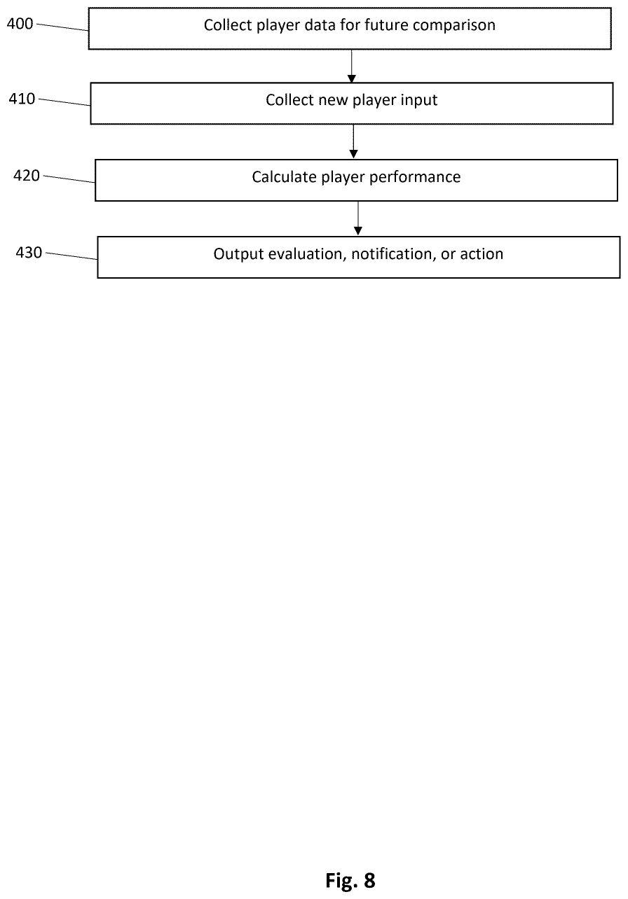

FIG. 8 is a flowchart depicting a method according to embodiments of the present invention. The operations of FIG. 8 may be performed with hardware systems as in FIGS. 9 and/or 10, but may be performed with other hardware systems.

In operation 400, data may be collected from players, e.g. providing input to games or gamified tasks. For example, data from a number of players may be collected to create a database or collection of player performance metrics, such as movement data, shot data, speed data, precision data, or other data. Such a data store may be used to compare a newly seen player to other players. Data from a single player to be evaluated may be collected, e.g. in an embodiment determining improvement of a user over time. In one embodiment, the data for each player is collected for more than one target type.

In operation 410, a player, e.g. a newly seen player or a player having provided input earlier in time, may provide input to a game or gamified task.

In operation 420, performance or motor acuity for the newly seen player may be calculated, evaluated or determined relative to a set of other players or the same player earlier in time (e.g. as collected in operation 400). This may be performed by, for example, determining, for a number of different target types (e.g., different target sizes), speed of the player (e.g. of shooting or movement) and one of precision, accuracy and variability of the player (e.g. of shooting or movement), and determining motor acuity or flicking skill based on the relationship between speed of the player and the one of precision, accuracy and variability of the player. This analysis may be performed by, e.g. statistical analysis, graphing, statistical analogies of graphing, or other methods as described herein. Performance may be calculated by for example, determining a line (e.g. a best-fit line) corresponding to or fitting with plots of a relationship of speed of the player and variability for a plurality of target types (e.g. a different plot for each target size); converting the line to a curve (e.g. by plotting a curve using the inverse of one of the line's parameters); and calculating performance based on the location of the curve in a graph (e.g. the distance of the curve from a graph origin or other point).

In operation 430 the evaluation may be output. The evaluation may be used, for example: to compare a number of players to determine which player has better skill or to compare an individual player over time to characterize that player's improvement over time. For example, the comparison may be used to determine the impact of equipment factors on performance (e.g., to show that a new gaming mouse is better than a competing product). Some embodiments maintain a database of players and their flicking skill assessment scores such that players are notified when they achieve a certain ranking in comparison to other players (e.g., top 10^{th} percentile). Some embodiments display a leaderboard of the top (e.g., 100) players with the highest flicking skill assessment scores. Some embodiments notify esports organizations, leagues, team owners, and coaches about flicking skill assessment rankings from each of a plurality of players.

Other operations or series of operations may be used.

Other measures of performance or motor acuity may be used. For input controllers that sense or measure physical movements (e.g., mouse, keyboard, eye tracker, motion capture, etc.), there are various methods for quantifying the accuracy of a player's movements. Input controllers may sense, measure, or estimate human movement and provide input signals to a computer to interact with the virtual environment. For example, the input signals could change 2D or 3D position and orientation of the virtual character or other on-screen object being controlled by the player, or the 2D or 3D position and orientation of a virtual object in the virtual environment of the game. In one embodiment, the input signals control a cursor that is rendered on a computer monitor. The accuracy of a player's movements can be quantified in terms of the physical movement in the real environment (e.g., the position or relative position of the mouse), or in terms of the virtual movement in the virtual environment (e.g., the position of a cursor that is controlled by the mouse). For example, the 2D screen position of a cursor on a computer monitor can be compared to the 2D projection of the 3D location of an object in the virtual environment. To do so, the computer converts a 3D location in the virtual environment to the corresponding 2D screen position that is the projection of that 3D location. In another embodiment, accuracy can be quantified in terms of the 2D or 3D position and orientation of a virtual object in the virtual environment. Human movements typically have multiple different stages. In one embodiment, the accuracy of the initial movement can be quantified. In another embodiment, the accuracy of the final end point after one or more of the corrective movements can be quantified together with the original movement. In another embodiment, the accuracies of each component movement can be quantified. The accuracy of an individual movement can be quantified as the error between the executed movement and the desired movement, for example, the difference between the end point of a cursor movement and the position of a target on the computer display. The accuracy may include the magnitude and/or direction of the error. In one embodiment, the distribution of such errors can be measured and characterized. The distribution of errors can be characterized by computing statistics from a plurality of such errors. Statistics that can be computed include mean, median, mode, variance, covariance, skewness, kurtosis, and higher order statistical moments. In another embodiment, the distribution of errors can be characterized by fitting a model to the plurality of such errors. The distribution of errors can be fit with a statistical model (e.g., a multivariate normal distribution). In another embodiment, the distribution of errors can be fit by a functional model (e.g., a model of the neural processing that controls eye movements or body movements). It is also recognized that various different statistical or functional models can be substituted, including those that have not yet been reduced to practice. Accuracy can be measured separately for each target or combined (e.g., by averaging) across targets.

The manipulation of the outcome of the input of the player, or the change in mapping or relationship to the input device, may include manipulating at least one of a position, velocity, acceleration, higher-order temporal derivative of the position, orientation, angular velocity, angular acceleration, higher-order temporal derivative of the orientation, joint angle, angular velocity of the joint angle, angular acceleration of the joint angle, and higher-order temporal derivatives of the joint angle of the input of the player.

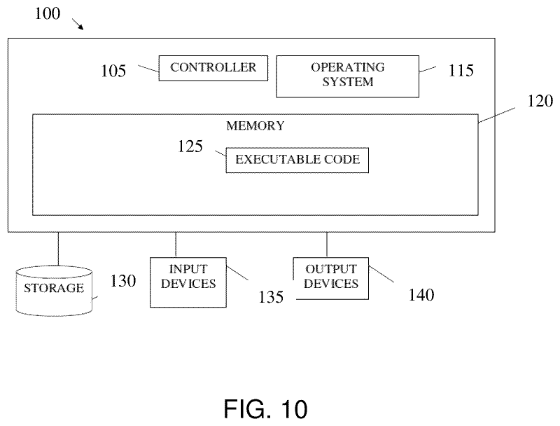

FIG. 9 depicts a computer system according to embodiments of the present invention. Embodiments may include one or more computer systems executing software to carry out methods as discussed herein. For example, a user computer 200 may be a desktop, laptop, personal computer (PC), cellular telephone, smartphone, or gaming console or computer (e.g. Xbox, Playstation, etc.), e.g. accepting user (e.g. gamer) input via an input device 205 (e.g. a mouse, Wii controller, iPad, etc.) to a video or computer game 210 and displaying gaming output (e.g. views such as displayed in FIGS. 1 and 2, e.g. on a computer monitor or display such as an output device 140 of FIG. 10. Game 210 and its user interface may be displayed by or in conjunction with other software such as an internet browser, the Steam game distribution service, or other software. Game 210 may execute all or partly on computer 200 and/or a remote computer such as server 300, which may be, e.g. a computer operated by a game or gamified task provider company, e.g. State Space Labs, Inc., a cloud computing facility, etc. Computer 200 may provide output such as a game display and may be connected e.g. via one or more networks such as the internet 290 to other computers such as server 300. User computer 200 and/or server 300 may assess gamer performance or skill, provide training, provide therapy, or provide other methods as discussed herein. User computer 200, server 300, and other systems may be computers for example including components in system 100 (FIG. 10).

In some embodiments, human participants or players provide input to a movement task (e.g. moving to the center of a circle) or other tasks such as gamified tasks, training, therapy, etc. remotely (e.g. from a server 300 providing a game) using their own gaming set-up such as user computer 200. A gaming set-up such as computer 200 may include for example hardware such as a PC, monitor (e.g. monitor 140 of FIG. 10), input device 205 (e.g. input device 135 in FIG. 10) and mousepad, and may operate based on settings (e.g. stored at computer 200 or server 300) such as display size, field-of-view, viewing distance, chair height or mouse counts per inch (CPI). Some embodiments work in conjunction with or take input from products from Aim Lab, such as Aim Lab's first-person shooter (FPS) assessment and training game. For example, a server 300 may execute an Aim Lab product such as a Sixshot task or Gridshot task, or a game such as a Fortnight video game or the Counter-Strike: Global Offensive (CS:GO) video game, and/or a user computer 200 may download and execute such tasks without processing being done on a remote server. Such tasks or games when executed may interact with a server 300 via internet connection 290. Analysis or creating a performance metric such as an FSA may be executed by user computer 200, server 300, or another system. A player may play (e.g. provide input to) such tasks, and the tasks may produce data (e.g. events, mouse or game controller movements, movement speed, movement precision, accuracy, other movement data, etc.), and from this data motor acuity, player performance, performance metrics, skill level, etc. may be produced, e.g. by user computer 200 and/or server 300.

The system of FIG. 9 may be a handheld device, such as a medical device. Such a handheld medical device, or a device including a game or other controller, may perform sensorimotor and cognitive assessment and/or therapy of a patient by using methods as described herein.

While one user computer 200 and one server 300 is shown, other embodiments may use multiple such computers, e.g. connected by a network such as internet 290.

FIG. 10 depicts a computer device according to embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system. The various embodiments and operations discussed herein may be executed by computing device(s) such as computing device 100.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or data such as documents, etc.

Executable code 125 may be any application, program, process, task or script. Executable code 125 may be executed by controller 105 possibly under control of operating system 115. For example, executable code 125 may be one or more applications performing methods as disclosed herein. In some embodiments, more than one computing device 100 or components of device 100 may be used. One or more processor(s) 105 may be configured to carry out embodiments of the present invention by for example executing software or code.

Input devices 135 may be or may include game controllers (e.g. a Wii controller), gyroscope sensors, EEG sensors, EMG sensors, a mouse, a keyboard, tablet computing device, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Some embodiments assess the deftness with which a player can adjust their performance in response to task demands. While playing an FPS game, an opponent can appear at a distant location (e.g., rendered as a small target on the player's screen), or at a nearby location (e.g., rendered as a large target on the player's screen). A good player can flexibly shift along their SAT function or line in response to such circumstances, prioritizing speed for nearby opponents (e.g., large targets) and prioritizing precision for distant opponents (e.g., small targets). Some embodiments compare performance when different target sizes are presented in separate rounds of play versus when the different target sizes are interleaved in each round of play. An ideal player will exhibit exactly the same performance in both cases (separate rounds versus interleaved). Most players will, however, exhibit a decrease in performance (e.g. flicking skill and/or movement kinematics) when the different target sizes are interleaved because that version of the task has the additional requirement that players must decide for each target how best to trade off speed versus precision. Hence, the use of a comparison of performance between playing with different target sizes in separate rounds versus interleaved characterizes a player's ability to optimize the trade-off of speed versus precision and improves the technology of performance evaluation. The ratio of FSA when different target sizes are interleaved versus when different target sizes are in separate rounds may be used as a measure of player's ability to optimize the trade-off of speed versus precision. Some embodiments maintain a database of players and their FSA ratio. Some embodiments notify players when they achieve an ranking of their FSA ratio in comparison to other players (e.g., top 10^{th} percentile), or display a leaderboard of the top (e.g., 100) players with the highest FSA ratios, or notify esports organizations, leagues, team owners, and coaches about FSA ratios. Any comparison of FSA when different target sizes are interleaved versus when different target sizes are in separate rounds may be substituted for an FSA ratio.

Some embodiments include a training program wherein an individual participates in a plurality of sessions across a plurality of days, the individual practices a plurality of repeats of each of a plurality of tasks during a training session, wherein each of the different tasks includes targets with different sizes and/or presentation durations, and wherein performance is assessed by flicking skill and/or movement kinematics for each session. Any changes or improvements in FSA may be displayed to the player as a graph or some other visual rendering.

In some embodiments, FSA is used to evaluate the impact of hardware, software, and various other factors (e.g., mouse, mouse pad, rendering latency, posture, exercise, diet and dietary supplements, sleep, etc.) on performance. Embodiments make a comparison of the FSA for a player or players across conditions, thereby providing actionable insights about such factors, for example, to make a choice about which mouse or mouse pad (or other hardware) to purchase or to offer advice about exercise, diet and sleep so as to optimize performance.

Some embodiments may improve rehabilitation technology, and may include gamified rehabilitation, for example, for patients recovering from or receiving therapy for stroke, traumatic brain injury, cerebral palsy, or arm injury. These embodiments may measure improvement in motor acuity over time. Some embodiments may improve concussion assessment, to determine if an individual may have suffered a concussion or brain injury, by comparing their performance with a baseline that was measured before the incident that may have caused an injury. Some embodiments include an assessment to determine if an athlete should return to play following a concussion. Some embodiments include assessment and training for individuals who are learning to use a prosthetic limb. Some embodiments include assessment and training for stroke rehabilitation. Some embodiments include assessment and training for patients with movement disorders (e.g., cerebral palsy). Embodiments may maintain a database of patients and their motor acuity scores over time, that may be displayed to the patients as a graph or some other visual rendering. Embodiments may provide a dashboard for clinicians to track the progress of their patients and to support decisions, e.g., about which interventions may be most effective or most appropriate, decisions about whether an athlete should be sidelined or allowed to play, etc.

The capacity of embodiments of the invention, e.g. using FSA, to provide, over a short period of time with no ceiling or floor effect, a measure of motor acuity independent of strategy and SAT, makes it an improvement over prior technology and tools for a wide range of both basic and applied research and therapies; for example, visuomotor psychophysics and rehabilitation. There is a paucity of academic studies examining motor acuity. Embodiments of the invention may fill this critical gap in the study of human motor behavior and visuomotor psychophysics. As with any other instance of motor skill learning that is characterized by reinforcement learning, physical rehabilitation aims to improve motor acuity. Rehabilitation must also assess performance to provide motivating feedback for the patient and clinically relevant data for the therapist or clinician to guide rehabilitation. Neuroplasticity drives motor learning, which depends on movement repetition and intensity. Neuroplasticity is also facilitated by active task engagement and enjoyment. Furthermore, calibrating task difficulty to an individual's skill level is critical for rehabilitation, because competency is an intrinsic motivator. Embodiments, e.g. an FSA method, may satisfy all of these criteria, and improve such technology, by for example providing a challenging, adaptive, and engaging task based on repetitive movement behavior. Incorporating FSA methods into gamified rehabilitation therapy technology may enable objective quantification of behavioral or motor performance (e.g., kinematics, dynamics), and may be rapidly and inexpensively deployed at scale and remotely provided to large populations.

Some embodiments include gamified assessment of sensorimotor and/or cognitive fitness or state. These embodiments can include immersive games for military personnel that execute on mobile devices (e.g. phone, tablet, etc.) and that assess and monitor changes in cognitive fitness, readiness, and performance across the military lifecycle and in the field. In some of these embodiments, baseline performance is measured in an initial session and repeated gameplay monitors changes in cognitive performance relative to an individual's baseline. In some embodiments, the assessment is sensitive to subtle changes in cognitive fitness (e.g., due to fatigue, injury, mental illness, drug or alcohol use, or any of a number of other factors). Embodiments may provide a dashboard for tracking the sensorimotor and cognitive fitness of personnel to support decisions, e.g., about whether intervention is warranted, whether personnel should be temporarily removed from active duty or returned to active duty, etc.

There are many advantages of the disclosed gamified assessments of sensorimotor and cognitive fitness over other approaches including standard neuropsychology assessments. Embodiments of a gamified assessment of sensorimotor and cognitive fitness may improve on assessment technologies, as embodiments may be entertaining, absorbing, objective, and easily distributable because they may not require specialized hardware, peripherals. Embodiments may not require the presence of a medical professional. Embodiments may be individualized (e.g., relative to each individual's baseline) and hence be sensitive to subtle changes in cognitive fitness that may be undetectable with a standard neuropsych battery. Embodiments may take less time to complete than a standard neuropsych battery.

Some embodiments detect, e.g., using a computer system as described herein, sandbagging (purposefully performing poorly on a baseline assessment) by analyzing performance variability. Human performance exhibits stereotypical error distributions. Although a player may attempt to sandbag (e.g., perform worse than they are capable of), they are unlikely to be able to mimic the stereotypical error distributions while sandbagging. In addition, players of lower skill will have less fast and more variable (or less precise or less accurate) responses overall but still follow speed-accuracy tradeoff incentives of the task, whereas players who intentionally sandbag would have poor speed and precision (or more variability or less accuracy) regardless of task incentives. Embodiments may notify coaches, commanding officers, managers, etc. when sandbagging is detected.

In one validation of some embodiments, performance data from 32 professional and semi-professional male esports players (mean age=22.47±3.62) were collected and then analyzed. The players specialized in different game titles: 4 for a Valorant game, 10 for a PUBG game, and 18 for a Rainbow Six Siege game. Each participant played several rounds of a Gridshot task and several rounds of a Sixshot task. It was predicted that players would exhibit systematic differences in movement behavior between Gridshot and Sixshot tasks. Gridshot's large target size incentivizes players to maximize score by moving as quickly as possible with relatively low shot precision. Sixshot targets are much smaller and require high precision, which consequently means that players are incentivized to slow down.

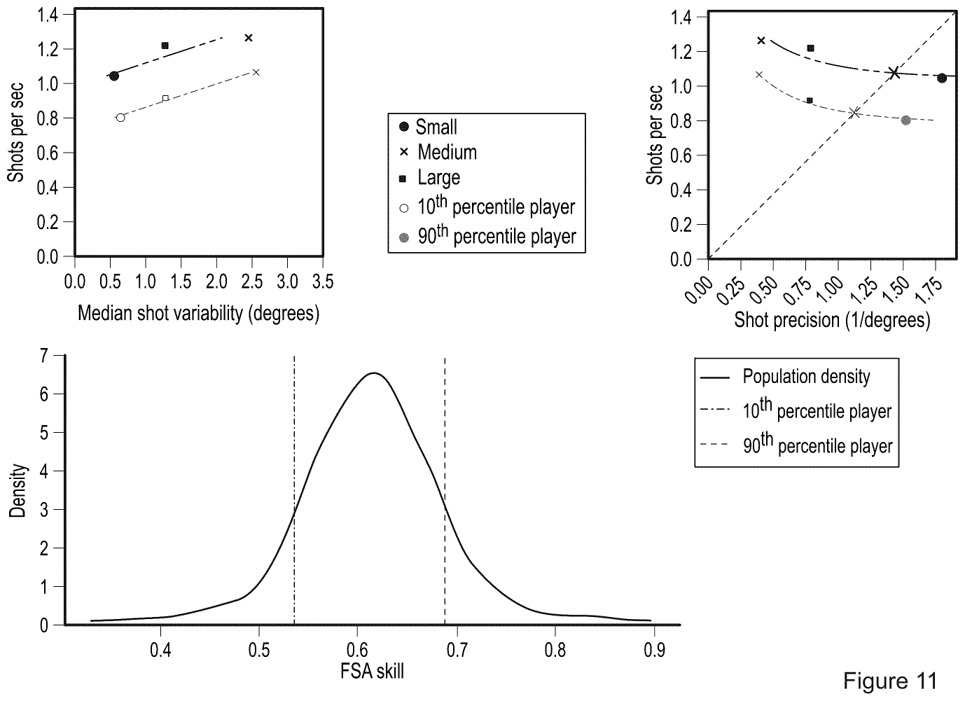

In one demonstration and validation of FSA, data was analyzed from a large number of amateur players, each of whom played multiple rounds of the Adaptive Reflexshot task with 3 different target sizes. Each round of play had a single target size and target presentation duration was titrated throughout each round of play based on the player's performance. Different target sizes were presented during separate rounds of play. FIG. 11 (top left panel) shows shot speed (in units of shots/sec) as a function of or in relation to shot variability (in units of degrees) for two example players, according to one embodiment. FIG. 11 (top right panel) shows shot speed (in example units of shots/sec) as a function of or in relation to shot precision (example units of 1 over (divided by) shot variability in units of degrees −1) for same two example players.

Some embodiments compare flicking skill across a number of players. FIG. 11 (bottom panel) shows an example distribution of flicking skill values across a group of amateur players. The flicking skill of two example players (FIG. 11, top two panels) are compared with the distribution of players (FIG. 11, bottom panel).

Embodiments may evaluate flicking skill and movement frequency. Human flicking performance typically exhibits variability and error. At times, a primary movement will have very little error, while others will require subsequent corrective movements to successfully land on and shoot a target. For large targets, it is expected that the proportion of targets destroyed which required a corrective movement would be fewer. This is because even with movement error, primary movements are more likely to land on the target. For small targets, on the other hand, players will often have to make corrective movements to accommodate for the targets being much smaller. In one example validation, data from pro (and semi-pro) esports players was used for validation. In this example validation the percentage targets that were destroyed with a single (primary) movement or with a pair of movements (primary and corrective), for each of two tasks, was used. A statistical analysis (e.g. using error bars) produced the standard deviation across players. The results reflected the predicted pattern, with the number of single-movements to destroy a target being greater in Gridshot tasks than in Sixshot tasks across all players. Similarly across all players, single-movements to destroy the target were less frequent than double-movements to destroy the target in Sixshot tasks. Furthermore, with the exception of two players, the opposite was true in Gridshot tasks; where the majority of targets destroyed was achieved following a single movement.

In one example validation for FSA, flicking skill is predictive of the number of movements required to destroy targets. Flicking skill may be plotted on an x-axis (e.g., after regressing out mouse sensitivity) and percentage of targets destroyed following a single-movement may be plotted on a y-axis for a Gridshot task and for a Sixshot task Such validation may use statistical results from Spearman's Rank Correlation: rho=Spearman's Correlation Coefficient and p=p-value; e.g. p-value<0.05. Flicking skill may in one validation be positively correlated with a proportion of targets that were destroyed with a single movement [p=4.19e−04] in Gridshot. This suggests that players with better flicking skill were more likely to require only a single movement to destroy a target, and therefore were more efficient with their movements in Gridshot.

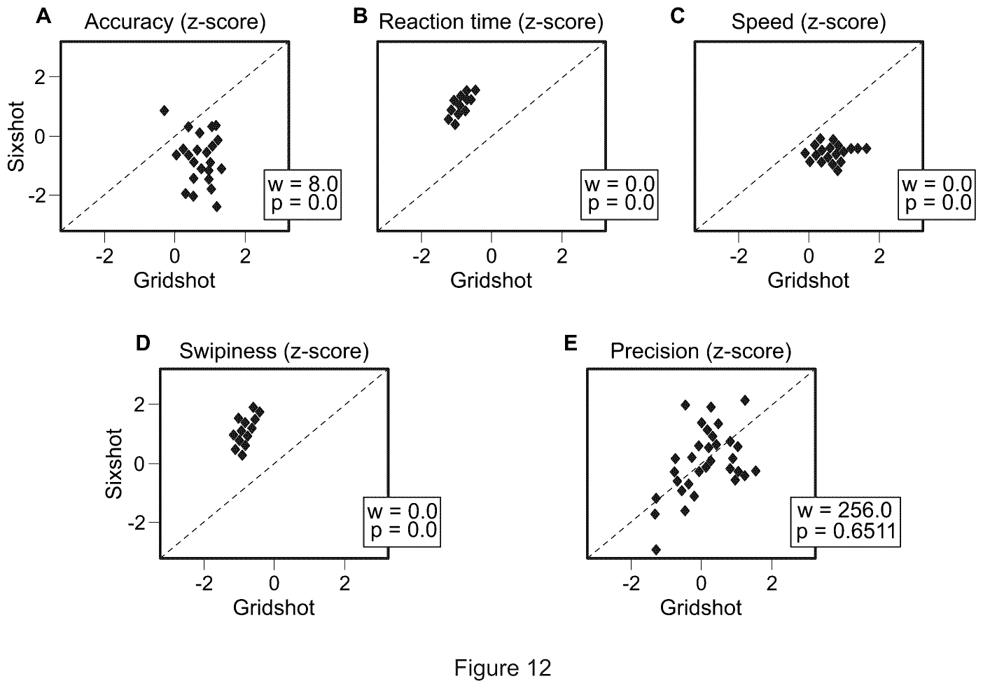

Movement kinematics may be task dependent. FIG. 12 provides an example validation of embodiments of the present invention for measuring movement kinematics and demonstrates that FSA reflects movement kinematics. FIG. 12 plots example movement kinematic metrics for a Gridshot task versus Sixshot task, with Gridshot on the x-axis and Sixshot on the y-axis. Each panel corresponds to a different movement kinematic metric for primary movements. Each data point within each panel corresponds to a different player. The dashed diagonal in each panel represents the values at which the movement kinematics are identical for Gridshot and Sixshot. The annotation boxes in FIG. 12 show statistical results from the paired Wilcoxon signed-rank test: where w=sum of ranks, and p=p-value. A p-value<0.05 indicates that the movement kinematics for Gridshot and Sixshot are statistically different. The results demonstrate that in this example players were more hypometric in Sixshot compared to Gridshot (Accuracy). Players were faster to react (Reaction time), they moved their mouse at a faster pace (Speed), and fired earlier in their movement trajectory (Swipiness) in Gridshot compared to Sixshot.

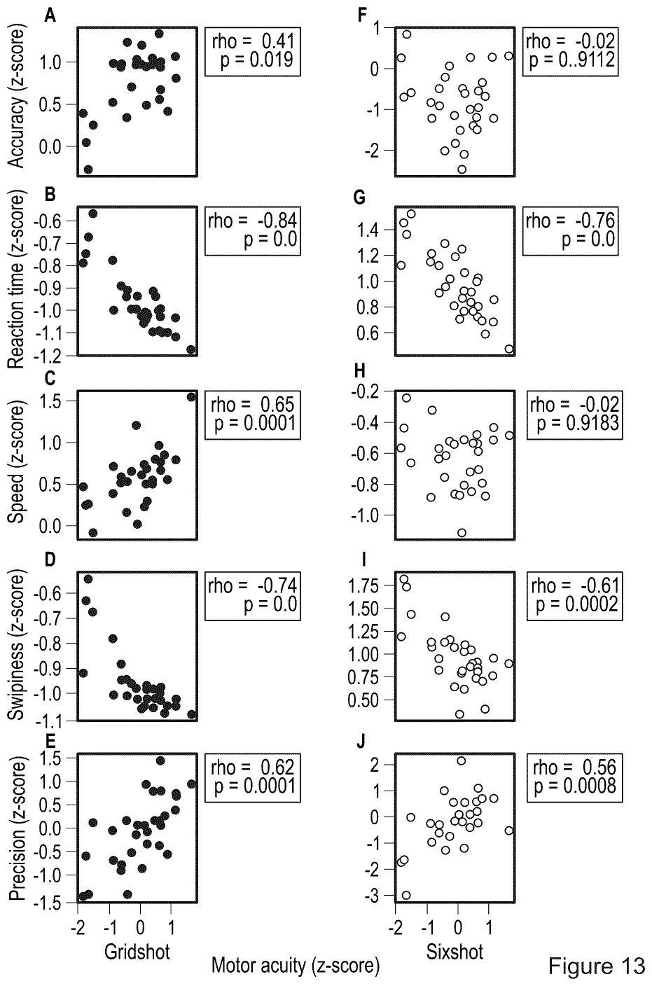

FIG. 13 provides an example validation of embodiments of the present invention, for FSA, that individual differences in flicking skill values (as determined by FSA) are predictive of individual differences in movement kinematics. Each panel in FIG. 13 plots one of the movement kinematic metrics on the y-axis (after z-scoring and regressing out mouse sensitivity) versus motor acuity (as measured with FSA) on the x-axis (again, after z-scoring and regressing out mouse sensitivity). Each data point within each panel corresponds to a different player. The left column of graphs plots the movement kinematics for Gridshot tasks and the right column of graphs plots the movement kinematics for Sixshot tasks. The annotation boxes in FIG. 13 show statistical results from Spearman's Rank Correlation: rho=Spearman's Correlation Coefficient and p=p-value. A p-value<0.05 indicates that FSA predicts individual differences in movement kinematics. For Gridshot, motor acuity was negatively correlated with reaction time and swipiness, while positively correlating with accuracy, speed, and precision. For Sixshot, motor acuity was negatively correlated with reaction time and swipiness, and positively with precision. For both tasks, the interpretation of these results is that players with greater motor acuity initiated movements more quickly, landed with lower variability, and fired shots earlier in the movement trajectory. Moreover, players with greater motor acuity exhibited faster movement speed and better (less hypometric) accuracy in Gridshot. Consequently, individual differences in FSA can be used as a proxy for measuring movement kinematics.

FIGS. 11-13, taken together, demonstrate the capability of embodiments to assess individual player flicking skill. These validation results reveal differences between professional-level FPS players, between amateur players, and between scenarios with different task demands:
Players adjust their strategy between tasks with different incentives for speed versus precision. This is evident in players' shot behavior, with a greater number of shots and greater spatial error when targets are large (Gridshot) and fewer shots and smaller spatial error when targets are very small (Sixshot).
Movement kinematics reflected task demands. Players initiated their movements to targets more quickly (e.g., with shorter reaction times) in Gridshot compared to Sixshot, and had higher movement speed (for both primary and corrective movements) in Gridshot. Players fired shots earlier in their movement trajectory (e.g., with lower swipiness values) in Gridshot compared to Sixshot. In other words, players adopt a more conservative strategy employed in Sixshot compared to Gridshot. The kinematics provided detailed information about the nature of this shift in strategy between tasks, which would otherwise be ambiguous since players could be increasing shot speed via many combinations of shifts in underlying kinematics. Specifically, players take longer to plan their movements, move slower, fire later in the trajectory, and are more likely to land hypometrically in Sixshot compared to Gridshot. As a result, players sacrifice speed for accuracy and display more bias towards conservative (hypometric) landing positions.
Players differ in the degree to which they can be both fast and accurate, as summarized by the placement of their speed-accuracy tradeoff curve. Those with a higher flicking skill value, e.g., their speed-accuracy tradeoff curves are further upwards and rightwards, or away from the origin, are faster and more accurate, and may have higher performance or motor acuity, than players with a lower flicking skill value.
Flicking skill correlates with a subset of the movement kinematics. Better flicking skill accompanied faster reaction times for both Gridshot and Sixshot, in addition to having greater precision and a tendency to shoot earlier in the trajectory (swipiness) for Gridshot. It is important to note that the flicking skill values and the values of the movement kinematic metrics, in this example validation, are derived from different performance metrics, shot performance metrics and movement kinematic metrics, respectively. Demonstrating a systematic relationship between the two is a key validation of FSA.
Flicking skill correlates with movement efficiency. Players could successfully destroy targets with a single movement more frequently in Gridshot compared to Sixshot, with the majority of targets in Sixshot being destroyed following a corrective movement.
Individual differences in flicking skill correlated with the proportion of targets in Gridshot that are destroyed with a single movement. In other words, those with higher flicking skill values tend to only need one movement to destroy a given target in Gridshot. This underscores the predictive power of FSA, as those with both greater shot speed and greater shot precision are also found to be more efficient, needing fewer movements while exhibiting better flicking skill.
To validate some aspects of embodiments of the present invention, professional esports athletes (specializing in several different game titles) were recruited to play two tasks (e.g. each task with a different target size), one of which incentivized speed and the other of which incentivized precision. To provide further validation, data was analyzed from a large number of amateur players. Each player's flicking skill was estimated by measuring the player's speed-accuracy tradeoff relationship—in one example shot speed (e.g. median shot time from appearance of a target to time of first shot, in some embodiments even if that first shot misses the target) versus shot precision (e.g., 1 divided by the median of the absolute values of shot errors)—for a number of different target types or sizes. An improvement over prior evaluation technology was found, in that individual differences in the disclosed invention were found to be highly predictive of individual differences in movement efficiency (e.g., number of movements needed to hit a target) and individual differences in movement kinematics (e.g., reaction time, precision, and swipiness).

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A computer-implemented method for adjusting the evaluation of input signals from a computer input device used by a player of a game, the method comprising:
monitoring, by at least one computer processor, input in a game by a player using a computer input device;
determining a performance metric of the input; and
adjusting, by the at least one processor, a relationship between an input received via the computer input device and the movement of a virtual object within the virtual environment of the game based on the performance metric.

2. The method of claim 1, wherein the relationship is selected from the group consisting of: one or more sensitivities of the computer input device; dots-per-inch moved by the virtual object for each unit of movement of the computer input device.

3. The method of claim 1, wherein the adjusting comprises setting one or more sensitivities on the computer input device.

4. The method of claim 1 wherein the performance metric comprises at least one of:
a distance between a projectile and a target; and a distance between a movement and the target.

5. The method of claim 1, wherein the computer input device comprises a device selected from the group consisting of a mouse; a game controller; a joystick; an accelerometer; a pointing device; a motion capture device; a Wii remote controller; an eye tracker; a computer vision system; a gyroscope; an absolute position headset; a six-degree-of-freedom headset; and an inside-out tracking headset.

6. The method of claim 1, wherein the input comprises aiming or targeting movement trajectories.

7. The method of claim 1, wherein adjusting the relationship comprises manipulating at least one of acceleration and velocity.

8. The method of claim 1, wherein the adjusting comprises manipulating at least one of a position, velocity, acceleration, higher-order temporal derivative of the position, orientation, angular velocity, angular acceleration, higher-order temporal derivative of the orientation, joint angle, angular velocity of the joint angle, angular acceleration of the joint angle, higher-order temporal derivatives of the joint angle of the input, DPI, lift-off distance, polling rate, button response/debounce time, and angle tuning.

9. The method of claim 1, wherein the virtual object is a virtual character.

10. The method of claim 1, wherein the adjusting of the relationship is performed by a computer program comprising the game.

11. The method of claim 1, wherein the adjusting of the relationship is performed by the input device.

12. The method of claim 1, wherein the performance metric is selected from the group consisting of movement kinematic performance metrics, shot performance metrics, speed, accuracy, precision, variability, position error reaction time, motor acuity, and score.

13. The method of claim 1, wherein determining a performance metric of the movements comprises determining a performance metric of trajectories of the movements.

14. The method of claim 1, wherein the performance metric is based on one or more of the group consisting of mean; median; mode; variance; covariance; skewness; kurtosis; movement speed; peak movement speed; shot speed; a measure based on a target presentation duration threshold; a measure based on target hit rate; a measure based on time between target spawn or appearance and the first shot fired; a measure based on movements per second; a measure based on shots per second; movement variability; shot variability; a measure based on spatial error of the landing point of a movement to the target; a measure based on median absolute difference between the endpoint of the movement and the center of the target; and a measure based on a target size threshold.

15. A system for adjusting the evaluation of input signals from a computer input device used by a player of a game, the system comprising:
a memory; and
a processor configured to:
monitor input in a game by a player using a computer input device;
determine a performance metric of the input; and
adjust a relationship between an input received via the computer input device and the movement of a virtual object within the virtual environment of the game based on the performance metric.

16. The system of claim 14, wherein the performance metric comprises at least one of: a distance between a projectile and a target; and a distance between a movement and the target.

17. The system of claim 14, wherein the computer input device comprises a device selected from the group consisting of a mouse; a game controller; a joystick; an accelerometer; a pointing device; a motion capture device; a Wii remote controller; an eye tracker; a computer vision system; a gyroscope; an absolute position headset; a six-degree-of-freedom headset; and an inside-out tracking headset.

18. The system of claim 14, wherein the relationship is selected from the group consisting of: one or more sensitivities of the computer input device; dots-per-inch moved by the virtual object for each unit of movement of the computer input device.

19. The system of claim 14, wherein the adjusting comprises setting one or more sensitivities on the computer input device.

20. The system of claim 14, wherein the input comprises aiming or targeting movement trajectories.

21. The system of claim 14, wherein adjusting the relationship comprises manipulating at least one of acceleration and velocity.

22. The system of claim 14, wherein the performance metric is based on one or more of the group consisting of mean; median; mode; variance; covariance; skewness; kurtosis; movement speed; peak movement speed; shot speed; a measure based on a target presentation duration threshold; a measure based on target hit rate; a measure based on time between target spawn or appearance and the first shot fired; a measure based on movements per second; a measure based on shots per second; movement variability; shot variability; a measure based on spatial error of the landing point of a movement to the target; a measure based on median absolute difference between the endpoint of the movement and the center of the target; and a measure based on a target size threshold.

23. The system of claim 14, wherein the adjusting comprises manipulating at least one of a position, velocity, acceleration, higher-order temporal derivative of the position, orientation, angular velocity, angular acceleration, higher-order temporal derivative of the orientation, joint angle, angular velocity of the joint angle, angular acceleration of the joint angle, higher-order temporal derivatives of the joint angle of the input, DPI, lift-off distance, polling rate, button response/debounce time, and angle tuning.

24. The system of claim 14, wherein the virtual object is a virtual character.

25. The system of claim 14, wherein the adjusting of the relationship is performed by a computer program comprising the game.

26. The system of claim 14, wherein the adjusting of the relationship is performed by the input device.

27. The method of claim 21, wherein the adjusting comprises setting one or more sensitivities on the computer input device.

28. A method for adjusting the evaluation of input signals from a computer input device used in a virtual environment, the method comprising:
monitoring, by a computer processor, input to the virtual environment using a computer input device;
determining a performance metric of the input;
adjusting, by the processor, a mapping between an input received via the computer input device and movement within the virtual environment based on the performance metric.

29. The method of claim 27, wherein the performance metric comprises at least one of: a distance between a projectile and a target; and a distance between a movement and the target.

30. The method of claim 26, wherein the computer input device comprises a mouse.

31. The method of claim 26, wherein the mapping is one or more sensitivities of the computer input device.
